(19) United States
(12) Patent Application Publication
(10) Pub. No.: US 2025/0292208 A1
(43) Pub. Date: Sep. 18, 2025

(54) REGULATORY APPROVAL SUBMISSION AND REVIEW

(71) Applicant: Medtronic MiniMed, Inc., Northridge, CA (US)

(72) Inventors: Robin Ann Wasserman, Westlake Village, CA (US); Andrew C. Guardia, Tampa, FL (US); Todd A. Andersen, Seabrook Island, SC (US); Amoolya Girish, Los Angeles, CA (US)

(21) Appl. No.: 18/607,066

(22) Filed: Mar. 15, 2024

(51) Int. Cl. G06Q 10/10

(52) U.S. Cl. CPC G06Q 10/103

(57) ABSTRACT

Disclosed herein are techniques for regulatory approval submission and review. In some embodiments, a regulatory approval submission and review system includes a repository configured to store a set of regulatory approval submission data and associated metadata for a medical product of a supplier, and a portal communicatively coupled to the repository and configured to filter the set of regulatory approval submission data and the associated metadata in the repository based on the associated metadata and users' roles to provide user specific data and metadata to users of the supplier and users of a regulatory agency.

### TECHNICAL FIELD

The present disclosure relates generally to regulatory approval submission and review.

### BACKGROUND

In existing regulatory approval submission and review processes (e.g., FDA approval processes), data may generally be collected manually and separately by companies seeking the approvals and regulatory agencies. For example, a medical product company may collect or generate information related to a product to be approved, and generate an executive summary for the product based on collected data. The executive summary may be saved as a pdf file that may include hundreds or thousands of pages and may point to many supporting documents using document names and/or hyperlinks. The executive summary and the supporting documents may be saved onto a portable storage medium (e.g., a USB drive) and sent to the regulatory agency, or may be uploaded to an online file exchange site. The regulatory agency, upon receiving the executive summary in the portable storage medium or from the online file exchange site, may review the submitted documents, collect some data independently, and provide feedback on the submission, for example, in deficiency letters, to the medical product company. The medical product company may then need to provide updated documents or other requested information to the regulatory agency in responsive to the deficiency letters. This process may be iterated until all sections of the submission are approved. This regulatory approval submission and review process may be inefficient, time consuming, and costly, resulting in wasted effort for both the regulatory agencies and medical product companies, prolonged review time, and delayed product release.

### SUMMARY

This disclosure relates generally to regulatory approval submission and review. More specifically, techniques disclosed herein relate to systems and methods for streamlining regulatory approval submission and review processes for both the medical product companies and the regulatory agencies, thereby accelerating product approval and regulatory release. The techniques disclosed herein may be practiced in a variety of ways, such as using a server, a processor-implemented method, a system comprising one or more processors and one or more processor-readable media, and/or one or more (non-transitory) processor-readable media.

According to certain embodiments, a regulatory approval submission and review system may include a repository and a portal communicatively coupled to the repository. The portal may be configured to: provide, via a first computing device of a submitter, a first user interface for submitting and updating a common set of regulatory approval submission data for medical product; store the common set of regulatory approval submission data to the repository; provide, via a second computing device of a regulatory agency, a second user interface for reviewing and providing feedback on the common set of regulatory approval submission data; and control access to respective subsets of the common set of regulatory approval submission data by the submitter and the regulatory agency. In some embodiments, the repository may be configured to store the common set of regulatory approval submission data in a multi-level hierarchical structure to enable a user to navigate to specific elements of the common set of regulatory approval submission data according to the multi-level hierarchical structure.

According to certain embodiments, a regulatory approval submission and review system may include a repository configured to store a set of regulatory approval submission data and associated metadata for a medical product of a supplier, and a portal communicatively coupled to the repository and configured to filter, based on the associated metadata and users' roles, the set of regulatory approval submission data and the associated metadata in the repository to provide user specific submission data and metadata to users of the supplier and users of a regulatory agency. In some embodiments, the associated metadata may include: a subset of public metadata that is accessible by the users of the regulatory agency and the users of the supplier; and one or more subsets of supplier metadata that are accessible by the users of the supplier but are not accessible by the users of the regulatory agency, one or more subsets of agency metadata that are accessible by the users of the regulatory agency but are not accessible by the users of the supplier, or a combination thereof. In some embodiments, the associated metadata may include, for example, comments, modifications, revision history, status, or other attributes associated with individual elements of the set of regulatory approval submission data.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

The above and other aspects and features of the disclosure will become more apparent in view of the following detailed description when taken in conjunction with the accompanying drawings wherein like reference numerals identify like elements.

FIG. 1 is a block diagram of an example of a regulatory approval submission and review system that can be used by both medical product companies and regulatory agencies according to certain embodiments.

FIG. 2 includes a flowchart illustrating an example of a regulatory approval submission and review process using the example of regulatory approval submission and review system of FIG. 1 according to certain embodiments.

FIGS. 3A-3D illustrate examples of user interfaces for regulatory approval submission by a medical product company according to certain embodiments.

FIGS. 4A-4C illustrate examples of user interfaces for regulatory approval review by a regulatory agency according to certain embodiments.

FIG. 5 illustrates an example of a user interface showing an example of a device description section of a submitted project according to some embodiments.

FIG. 6 illustrates an example of a user interface showing an example of a manufacturing process planner section of a submitted project for the medical device shown in FIG. 5 according to certain embodiments.

FIG. 7 illustrates an example of a user interface showing a completed project according to certain embodiments.

FIG. 8 illustrates an example of a user interface showing an example of end-to-end risk management with links to details of potential risks according to certain embodiments.

FIG. 9 illustrates an example of a dashboard according to certain embodiments.

FIG. 10 illustrates another example of a dashboard according to certain embodiments.

FIG. 11 illustrates an example of a medical product company knowledgebase generated using the regulatory approval submission and review system disclosed herein according to some embodiments.

FIG. 12 illustrates an example of using the regulatory approval submission and review system disclosed herein by a medical product company to perform other functions according to certain embodiments.

FIG. 13 includes a flowchart illustrating examples of operations that may be performed by the regulatory approval submission and review system disclosed herein according to certain embodiments.

FIG. 14 includes a flowchart illustrating examples of operations that may be performed by the regulatory approval submission and review system disclosed herein according to certain embodiments.

FIG. 15 is a block diagram of an example of a computer system, which can be utilized to implement embodiments described herein.

The figures depict embodiments of the present disclosure for purposes of illustration only. One skilled in the art will readily recognize from the following description that alternative embodiments of the structures and methods illustrated may be employed without departing from the principles, or benefits touted, of this disclosure.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

Techniques disclosed herein relate generally to regulatory approval submission and review. More specifically, techniques disclosed herein relate to systems and methods for providing a common platform and a streamlined process for regulatory approval submission and review to both regulatory agencies and medical product companies to accelerate product approval and regulatory release and improve product quality.

As described above, existing regulatory approval submission and review processes may be inefficient, time consuming, and costly, resulting in wasted effort for both regulatory agencies and medical product companies, prolonged review time, and delayed product release. According to some embodiments disclosed herein, a common set of submission data and metadata for each product to be approved may be created as part of the submission process, and may be maintained in a repository of a regulatory approval submission and review system that is accessible by both the regulatory agency and the submitter that requests for the regulatory approval. The common set of submission data and metadata may include artifacts in various formats, and may be organized in a multi-level hierarchical structure for each project, such that users can easily navigate to elements of the common set of submission data to drill down to the desired level of detail and specificity for reviewing, commenting, and/or updating. For example, the multi-level hierarchical structure may include elements at different levels, such as a company level, a project level, a section level, a subassembly level, a device or component level, and the like. In one example, the submission data for each product/project may be organized in a hierarchical structure that includes multiple sections (e.g., clinical, sterilization, biocompatibility, device description, human factors, labeling, marketing, research and development, and risk management sections). Each section of the submission data may include sub-modules that provide further details in, for example, subassembly, component, and/or process/operation step level. The access to different elements of the common set of submission data and metadata may be controlled (e.g., filtered) by a portal of the regulatory approval submission and review system, where different entities may have access to different subsets of data and/or metadata.

After the medical product company submitted an approval request, the regulatory agency may receive notification from the regulatory approval submission and review system, and may access the submission through the portal and a user interface for the regulatory agency. Since the submission data is organized in a hierarchical structure and includes multiple sections, it can be easy for the agency to assign different sections (or other elements such as subassemblies, components, steps, etc.) to different experts for review. In addition, for each section, the expert may review and provide evaluation, comments, questions, decisions, or other feedback regarding specific elements to the common set of submission data and metadata. The individual elements with feedback from the regulatory agency may be highlighted, color coded, or otherwise clearly indicated, such that the medical product company may focus the response on the specific elements. In some embodiments, notifications may be sent to team members of the medical product company responsible for the specific elements. The responsible team members of the medical product company may review and respond to the feedback, such as providing revised or additional data, modifying a specific component, adding a new component, and the like. The responses, updates, and/or changes may also be clearly indicated (e.g., color coded, marked, highlighted, or otherwise indicated), such that the regulatory agency may focus the further review on the updates and changes. The real-time approval status and progress of each project or each element (e.g., each section, or each component/step) of the project can also be clearly indicated and presented to the users.

In this way, comments and changes can be made to individual elements, rather than the whole submission. For example, the regulatory agency may be able to drill down to the detail of a particular component in the bill-of-material (BOM) or a particular step of the fabrication or application process of a medical device, and make comments on specific deficiency of the particular component or step. The medical product company may also be able to drill down to the detail of a particular component or step to review the feedback, and provide response or update for only the particular component or step, rather than resubmitting the whole regulatory approval submission package. In addition, since the regulatory agency and the medical product company using the regulatory approval submission and review system disclosed herein can comment on or modify specific elements of the common set of submission data and metadata electronically and interactively during the regulatory approval process, responses or updates regarding the specific elements can be provided by the other party with minimum delay. Incomplete projects, incomplete sections of a project, and/or incomplete review of specific components/steps can be easily identified to gain more attentions of the users. As such, efficiency may be improved and review time may be reduced.

The access to different contents of the common set of submission data and metadata may be controlled (e.g., filtered) by a portal of the regulatory approval submission and review system, where different entities may have access to different subsets of submission data and/or metadata through user dashboard. The portal of the regulatory approval submission and review system may implement various control and filtering mechanisms. For example, some subsets of submission data or metadata may only be accessible by the medical product company, some subsets of submission data or metadata may only be accessible by the regulatory agency, while some subsets of submission data or metadata may be accessible by both the regulatory agency and the medical product company. In some implementations, different team members of the regulatory agency or the medical product company with different responsibilities or job functions may have access to different subsets of submission data or metadata. In some implementations, key performance indicators (KPIs), metrics, and other analysis results or reports (e.g., risk or impact analysis results) may be generated based on users' roles and accessible though user dashboards. In one implementation, when making a comment or generating other metadata regarding an element of the submission data, a user may indicate whether the metadata belongs to a common subset or an internal (private) subset, and such information may be saved as a part of the metadata saved with the corresponding element of the submission data, such that the portal may filter the common set of submission data and metadata based on a user's role to show only submission data and metadata intended to be viewable by the user. For example, the portal may filter the comments or other metadata, such that a regulatory agency expert may be able to review the common subset of metadata and the internal subset of metadata of the regulatory agency (but not the internal subset of metadata of the medical product company). Similarly, the portal may filter the metadata in the common set of submission data and metadata, such that a user from the medical product company may be able to review the common subset of metadata and the internal subset of metadata of the medical product company (but not the internal subset of metadata of the regulatory agency). In some embodiments, some submission data may be filtered based on attributes of the associated metadata and users' roles.

In some embodiments, the medical product company may build knowledgebases based on the comments or other feedback from the regulatory agency and/or progress and results of the review. For example, the comments/feedback may be categorized and can be searchable in the knowledgebase based on, for example, project name, keyword, country/region, reviewer, submitter, etc. The medical product company may learn from the knowledgebase such that future submissions can have higher quality, the number of iterations/revisions can be reduced, and the review process can be shorter. In some embodiments, electronic manuals may be automatically generated based on the common set of submission data and metadata, and may be automatically updated based on the comments and the responses (e.g., changes or updates made to the product). In some embodiments, the regulatory approval submission and review system may include built-in logic or functions for evaluating product release, automatic reporting functionality, automatic generation of emails and notifications, automatic data and/or format validation, project administration, resource management, and the like.

In this way, a connected, digital thread from product design to product release, involving both the medical product company and the regulatory agency, may be created for each product to be approved using the regulatory approval submission and review system disclosed herein. The regulatory approval submission and review system disclosed herein may enable improved submission and approval forecast, reduce submission preparation time, reduce the probability of submission rejection/conversion, reduce review duration, enable shorter response time to agency inquiries, improve quality of submissions, and reduce product release time. The regulatory agency using the regulatory approval submission and review system disclosed herein may receive submissions faster, have better visibility to workload for better resource planning, communicate more efficiently with the medical product company regarding deficiencies and supporting information, have clear understanding of the devices and changes, reduce evaluation time, and improve evaluation quality. As such, the regulatory approval submission and review system may improve both the efficiency and quality of the regulatory approval submission and review with reduced review time, such that consumers may have faster access to innovative products with increased quality and safety.

In the following description, for the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, operations, and techniques may be shown without necessary detail or may not be shown, in order to avoid obscuring the examples. The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example” is not necessarily to be construed as preferred or advantageous over other embodiments or designs.

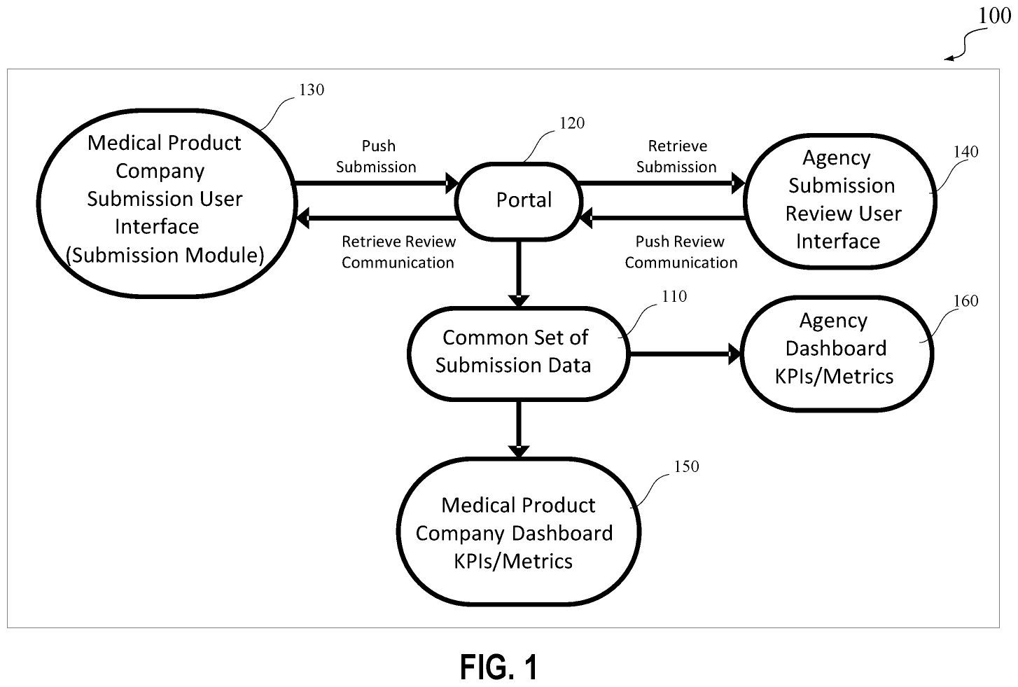

FIG. 1 is a block diagram of an example of a regulatory approval submission and review system 100 that can be used by both medical product companies (e.g., a pharmaceutical or medical device company) and regulatory agencies according to certain embodiments. In the illustrated example, regulatory approval submission and review system 100 may include a repository 110 that hosts a common set of submission data and metadata for each product being reviewed, and may also include a portal 120 that may control the content that can be accessed by different users having different roles. Portal 120 may communicate with user interface devices (e.g., user computers or terminals) to provide user interfaces for accessing the common set of submission data and metadata stored in repository 110. For example, portal 120 may receive data from and/or transmit data to a medical product company and a regulatory agency using a medical product company submission user interface 130 and an agency submission review user interface 140, respectively. Repository 110 and/or portal 120 may also host applications or engines that can generate analysis results or reports. In the illustrated example, the applications or engines may include an agency dashboard application 160 that may generate analysis results or reports and present the analysis results or reports in an agency dashboard through portal 120. The applications or engines may also include a medical product company dashboard application 150 that may generate analysis results or reports and present the analysis results or reports in a medical product company dashboard through portal 120. Even though only one medical product company submission user interface 130 and one agency submission review user interface 140 are shown in the illustrated example, regulatory approval submission and review system 100 may provide one or more user interfaces for one or more medical product companies and one or more user interfaces for one or more regulatory agencies. In various embodiments, regulatory approval submission and review system 100 may be implemented using one or more computing system, such as one or more servers.

To request agency approval of a medical product (e.g., a medical device), the medical product company may create artifacts or other supporting data in various formats, such as documents, videos, figures, design files, other multimedia content, and the like. The data created by the medical product company may include data related to user needs, design history, product design, device description, manufacturing, sterilization, biocompatibility, benefit/risk analysis, risk management, and the like. The medical product company may upload the created artifacts and other supporting data to regulatory approval submission and review system 100 through medical product company submission user interface 130 and portal 120, to create a set of submission data for the product in repository 110, and submit a request for review and approval. In some embodiments, the submission data may include associated metadata, such as comments, revision history, tracked changes, and the like. In some embodiments, an executive summary may be generated based on the artifacts and other supporting data, and submitted using medical product company submission user interface 130, portal 120, and/or repository 110.

The set of submission data in repository 110 may be a common set of submission data shared by the medical product company and one or more regulatory agencies, and may include documents, multimedia content, interactive content, or any other type of data, rather than merely documents (e.g., in PDF or Word format) as in the existing submission process. The common set of submission data (including associated metadata) in repository 110 may be organized in multi-level hierarchical structure that includes elements in, for example, a project level, section level, subassembly level, component level, and the like. In one example, the submission data for each product/project may be organized in a hierarchical structure that includes multiple sections, such as clinical, sterilization, biocompatibility, device description, device fabrication, human factors, labeling, marketing, research and development, and risk management sections, as described in detail below. Each section of the submission data may include one or mor sub-modules that provide further details in, for example, subassembly, component, and/or process/operation step level, and the like. As such, it may be easy for a user to navigate and drill down to the details of specific issues or specific components/operations of a product for reviewing, commenting, and/or updating. The access to different contents of the common set of submission data may be controlled (e.g., filtered) by portal 120, where different entities may have access to different subsets of the submission data and/or metadata.

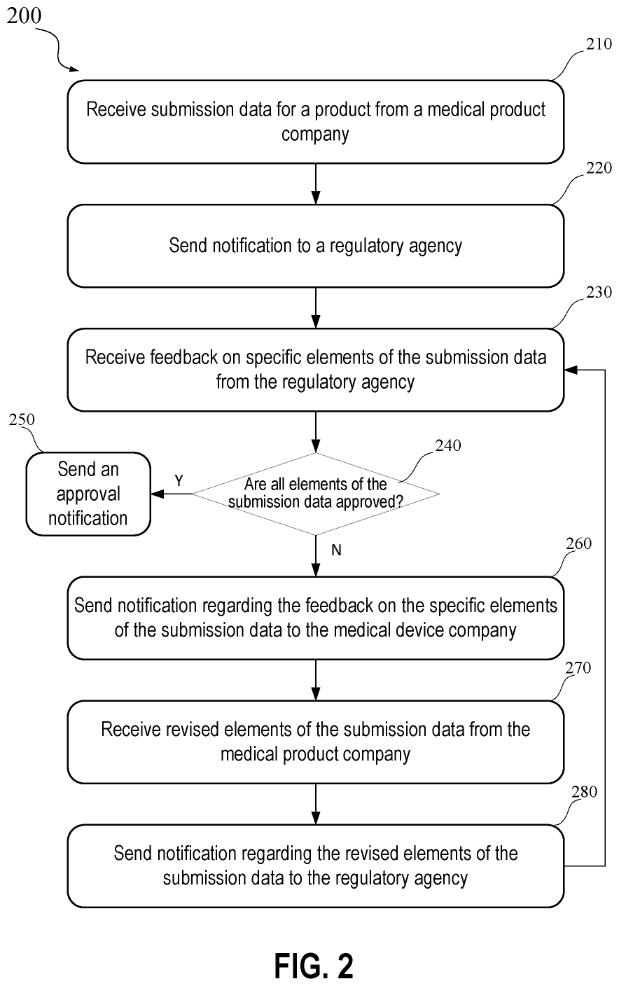

FIG. 2 includes a flowchart 200 illustrating an example of a regulatory approval submission and review process using a regulatory approval submission and review system disclosed herein (e.g., regulatory approval submission and review system 100) according to certain embodiments. In the illustrated example, at block 210 of flowchart 200, regulatory approval submission and review system 100 may receive, for example, via medical product company submission user interface 130 and portal 120, a set of submission data for a product to be approved from the medical product company, and may save the submission data in a hierarchical structure in repository 110 as described above. The medical product company may submit an approval request with or after completing the upload of the submission data.

After receiving the approval request, regulatory approval submission and review system 100 may send notification, via agency submission review user interface 140 and portal 120, to the regulatory agency at block 220. In some embodiments, the notification may be sent as a message (e.g., a text message) or an e-mail. Upon receipt of the notification of an approval request, the regulatory agency may access the submission data through agency submission review user interface 140 and portal 120. Since the submission data is organized in a hierarchical structure and includes multiple sections, it can be easy for the regulatory agency to assign different sections (or other elements) of the submission data to different experts. For each section, the expert may, via agency submission review user interface 140 and portal 120, review the submission data by navigating through the hierarchical structure.

At block 230, regulatory approval submission and review system 100 may receive, via agency submission review user interface 140 and portal 120, the review feedback regarding specific sections or other elements of the submission data from the regulatory agency. The review feedback may include evaluation, comments, questions, review decisions, or other feedback regarding specific elements (e.g., sections, components, steps, etc.). If all elements of the submission data meet the regulatory requirement, the feedback may indicate that the submission may be approved. Otherwise, the specific sections, components, steps, or other elements that may not meet the regulatory requirement may be identified, and the specific deficiencies (e.g., errors, incomplete data, or informality) may be provided, for example, as metadata associated with the submission data or as separate documents or messages (e.g., text or e-mail messages). The individual specific components or steps with feedback from the regulatory agency may be highlighted, color coded, in tracked changes, or otherwise clearly indicated, such that they may be easily identified and noticed.

At block 240, regulatory approval submission and review system 100 may determine whether all elements of the submission data for a product have been approved by the regulatory agency. If all elements of the submission data for a product have been approved, regulatory approval submission and review system 100 may send approval notification to the medical product company, for example, using a letter, e-mail, text message, or in another form, at block 250. If any element of the submission data has not met the regulatory requirement, regulatory approval submission and review system 100 may send a notice regarding the review feedback on the specific element of the submission data to the medical device company at block 260. In some embodiments, the notice may include links to the specific elements of the submission data. In some embodiments, notifications may be sent to team members of the medical product company responsible for the specific elements (e.g., specific components or steps) of the submission data. The responsible team members of the medical product company may review and respond to the feedback, such as providing revised or additional data, modifying a specific component, adding a new component, and the like. Because the specific elements with the feedback are clearly identified, the medical product company may focus the response on the specific elements of the submission data.

Regulatory approval submission and review system 100 may receive the revised elements of the submission data from the medical product company at block 270, and may send notification regarding the revised elements of the submission data to the regulatory agency at block 280. The responses, updates, and/or changes may be clearly indicated (e.g., color coded, marked, highlighted, or otherwise indicated) in the revised elements of the submission data, such that the regulatory agency may focus the further review on the updates and changes. The real-time approval status and progress of each project, each section, or each component/step can also be clearly indicated in user interfaces or dashboards. The operations at blocks 230, 240, and 260-280 may be performed iteratively until all elements of the submission data are approved.

In the regulatory approval submission and review system and process described above, comments and changes can be made to individual elements, such as individual sections, individual issues, or individual components, rather than the whole submission. For example, the regulatory agency may be able to navigate through the submission data and drill down to the detail of a particular component in the bill-of-material (BOM) or a particular step of the fabrication or application process of a medical device, and make comments on specific deficiencies of the submission data for the particular component or step. The medical product company may also be able to drill down to the detail of the particular component or step, and provide response or update for only the particular component or step, rather than resubmitting the whole regulatory approval submission package. Since the regulatory agency and the medical product company using the regulatory approval submission and review system disclosed herein can comment on or modify specific portions of the common set of submission data and metadata electronically and interactively during the regulatory approval process, responses or updates regarding the specific portions can be provided by the other party with minimum delay. Incomplete projects, incomplete sections of a project, and/or incomplete review of specific components/steps can be easily identified to gain more attentions of the users. As such, efficiency may be improved and review time may be reduced.

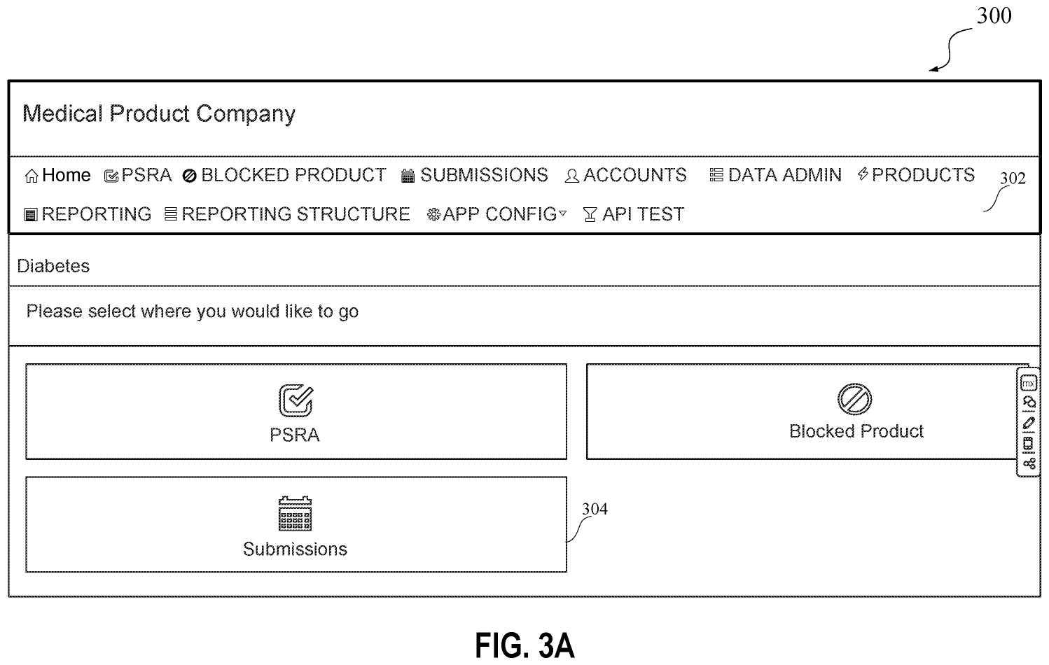

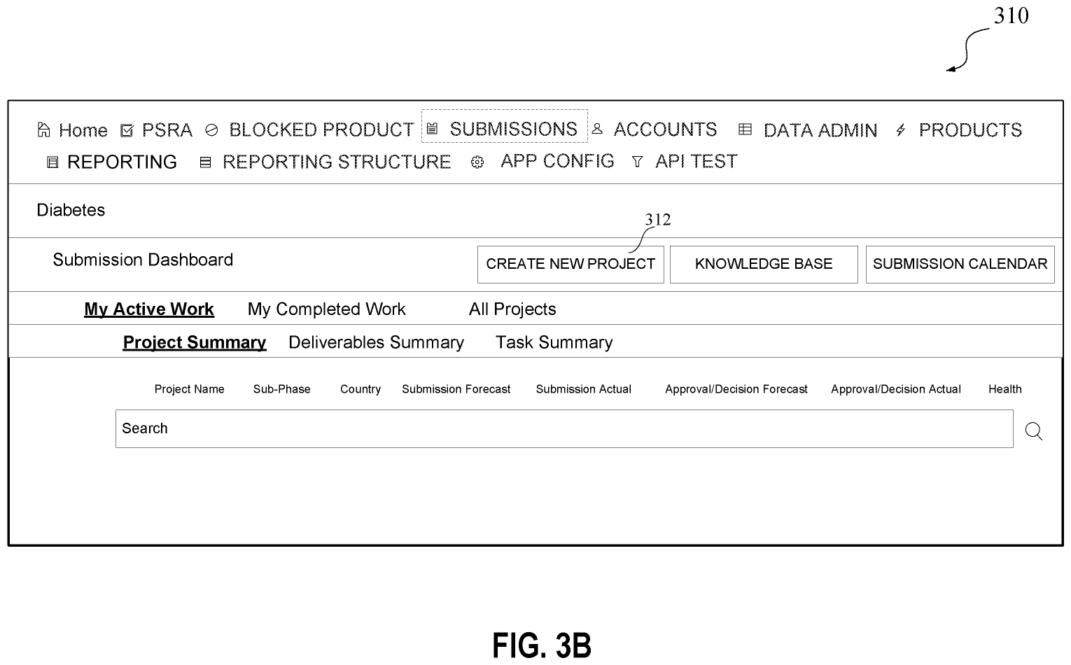

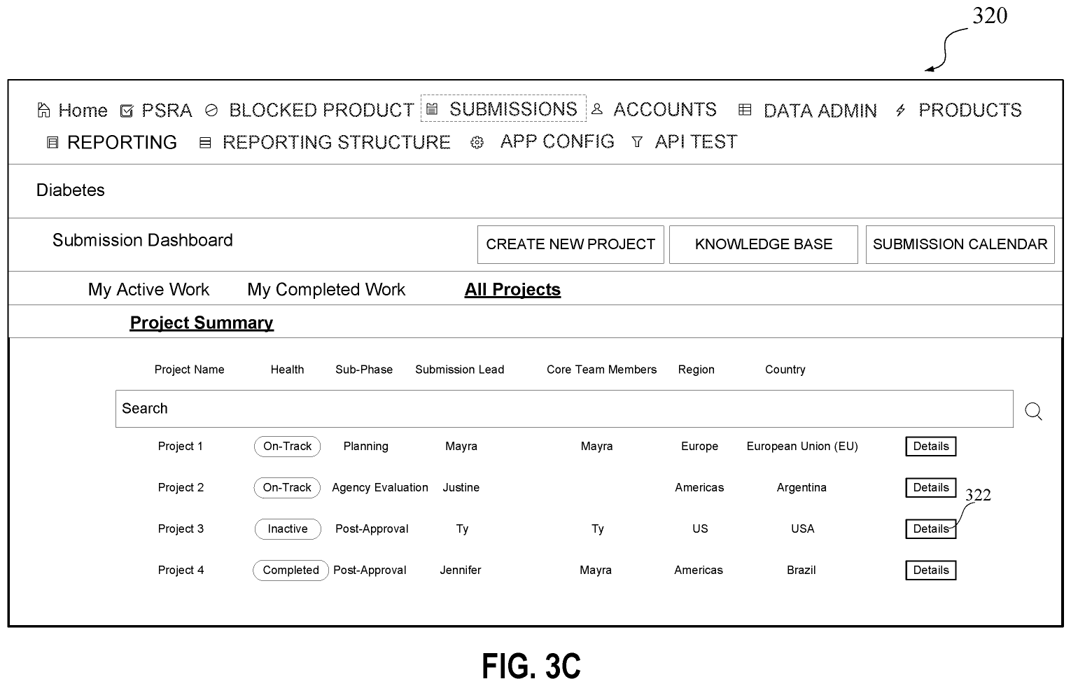

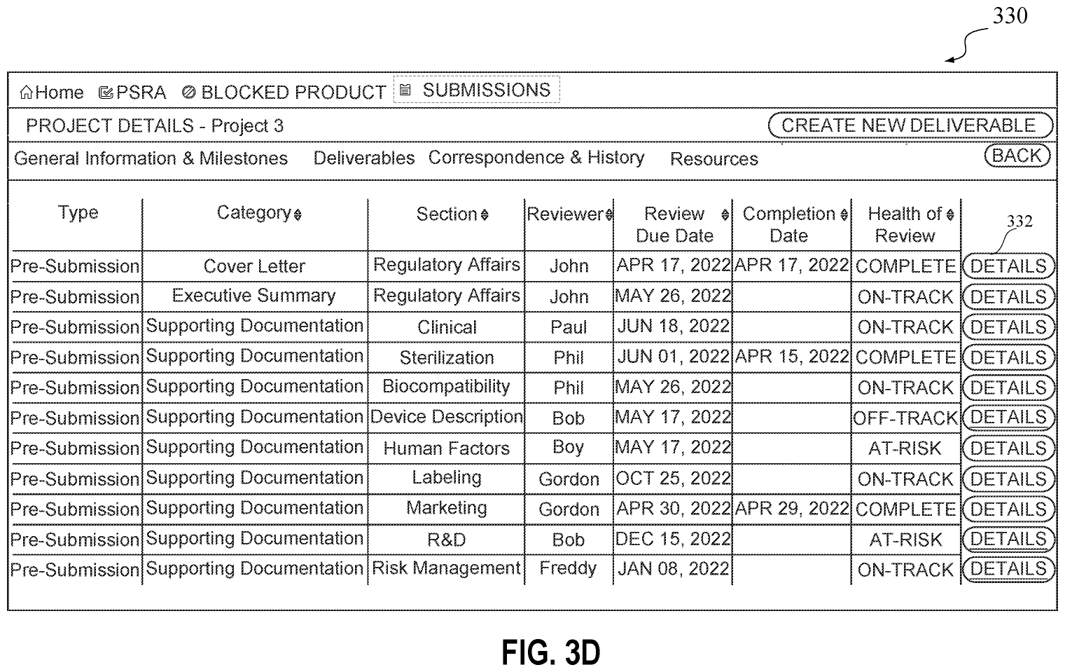

FIGS. 3A-3D illustrate examples of user interfaces for regulatory approval submission by a medical product company according to certain embodiments. In the example shown in FIG. 3A, a user interface 300 for a medical product company may include a menu 302 and/or buttons 304 that may be selected by a user to access a product safety and regulatory affair (PSRA) dashboard, a blocked product dashboard, a submission dashboard, and the like. For example, if a user of the medical product company needs to review status of existing regulatory submissions or start a new submission, the user may select “Submissions” in menu 302 or the “Submissions” button in buttons 304.

FIG. 3B illustrates an example of a user interface 310 that shows an example of a submission dashboard according to certain embodiments. The user may use the submission dashboard to, for example, create a new project (e.g., using a button 312), access a knowledgebase that includes information related to regulatory submission and review processes, review a submission calendar, and the like. From the submission dashboard, the user may also search and/or review completed projects or personal work, active projects or personal work, all projects, and the like. For each project, the user may review the project summary, deliverable summary, task summary, and the like, and may review details of a selected project.

FIG. 3C illustrates an example of a user interface 320 that shows an example of a submission dashboard showing project summaries according to certain embodiments. In the illustrated example, the submission dashboard shows the project summaries of all projects. For each project, the summary may include, for example, the name of the project, the health (status) of the project, the current phase or sub-phase of the project, the lead person of the submission of the project, core team members of the project, the region and/or country of the project, and the like. The user may review the details of a project at the project level of a multi-level hierarchical structure of submission data by clicking a corresponding button 322 that may include a hyperlink to the project.

FIG. 3D illustrates an example of a user interface 330 that shows an example of details of a project according to certain embodiments. The example shown in user interface 330 is a project-level view of a multi-level hierarchical structure of submission data stored in the regulatory approval submission and review system. From user interface 330, the user may review general information and milestones of the project, deliverables, correspondence and history, resources, and the like. User interface 330 also shows various sections of the submission data of a project, such as regulatory affairs, clinical, sterilization, biocompatibility, device description, device fabrication, human factors, labeling, marketing, research and development, risk management sections, and the like. The submission type (e.g., pre-submission), category, regulatory agency reviewer, review due date, completion date, health (status) of the review, and the like of each section may be provided, and a link to the details of each section may also be provided (e.g., via a corresponding button 332 that may include a hyperlink) such that the user may review each section in detail. As shown by FIGS. 3C and 3D, the submission data may be stored and reviewed using a multi-level hierarchical structure that includes, for example, a project level, a section level, a sub-assembly level, a component level, and the like, as described in more detail below.

After the medical product company submitted an approval request, the regulatory agency may receive notification from the regulatory approval submission and review system, and may access the submission through the portal and a user interface for the regulatory agency. Since the submission data is organized in a hierarchical structure and includes multiple sections, it can be easy for the agency to assign different sections (or other elements such as subassemblies, components, steps, etc.) to different experts for review. In addition, for each section, the expert may review and provide evaluation, comments, questions, decisions, or other feedback regarding specific elements to the common set of submission data and metadata. The individual elements with feedback from the regulatory agency may be highlighted, color coded, or otherwise clearly indicated, such that the medical product company may focus the response on the specific elements. In some embodiments, notifications may be sent to team members of the medical product company responsible for the specific elements. The responsible team members of the medical product company may review and respond to the feedback, such as providing revised or additional data, modifying a specific component, adding a new component, and the like. The responses, updates, and/or changes may also be clearly indicated (e.g., color coded, marked, highlighted, or otherwise indicated), such that the regulatory agency may focus the further review on the updates and changes. The real-time approval status and progress of each project or each element (e.g., each section, or each component/step) of the project can also be clearly indicated and presented to the users.

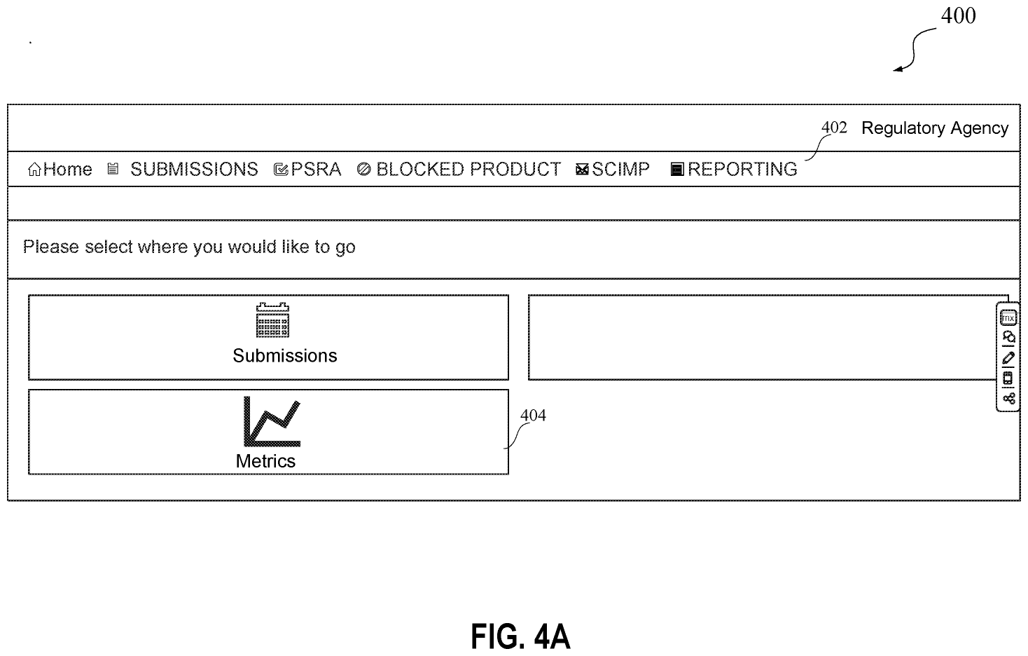

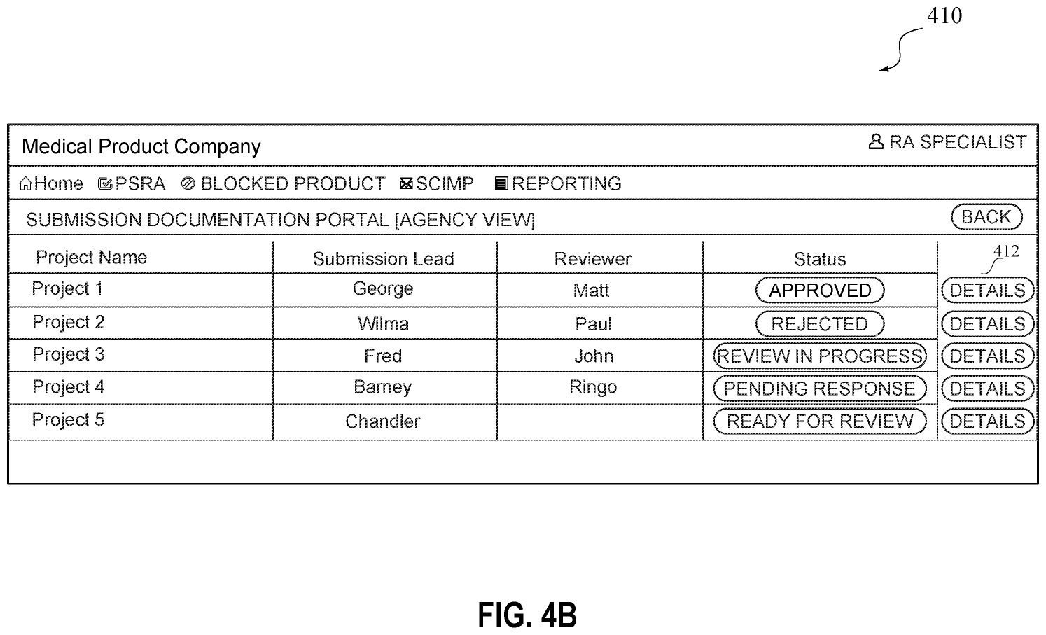

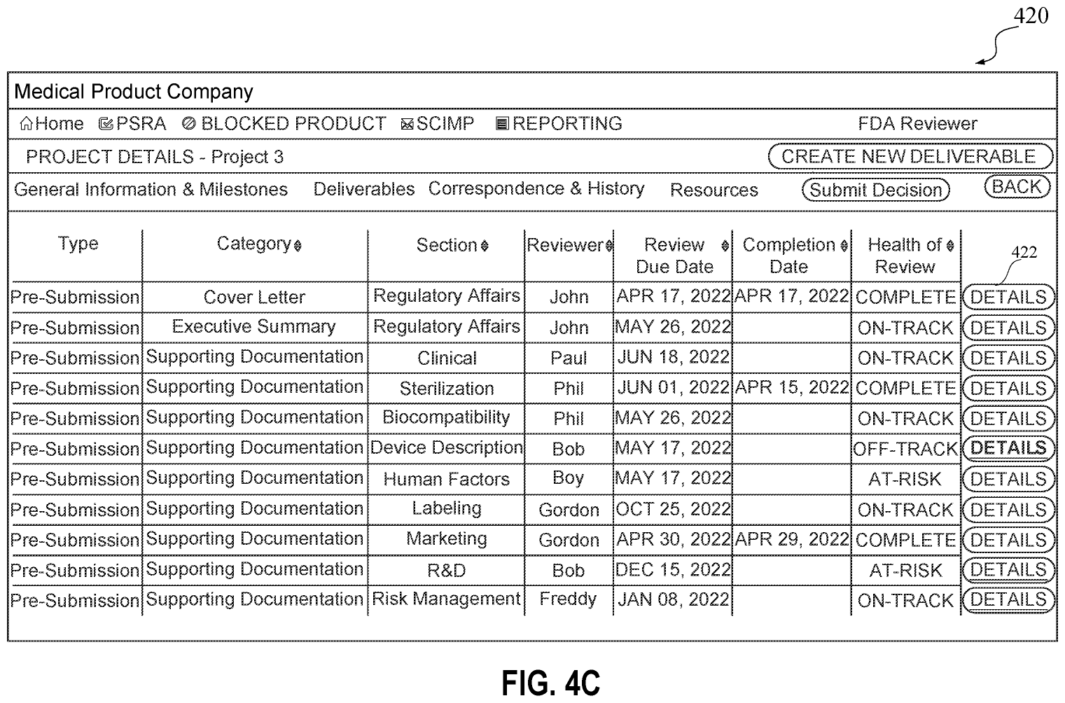

FIGS. 4A-4C illustrate examples of user interfaces for regulatory approval review by a regulatory agency according to certain embodiments. In the example shown in FIG. 4A, a user interface 400 for a regulatory agency, such as U.S. Food & Drug Administration (FDA), may include a menu 402 and/or buttons 404 that may be selected by a reviewer to access a submission dashboard, a metrics dashboard, and the like. For example, if a reviewer of the regulatory agency needs to review status of existing regulatory submissions or review a submission, the reviewer may select “Submissions” in menu 402 or a “Submissions” button in buttons 404.

FIG. 4B illustrates an example of a user interface 410 that shows an example of a submission dashboard for a regulatory agency according to certain embodiments. A reviewer of the regulatory agency may use the submission dashboard to review the list of projects (e.g., projects associated with a specific medical device company), and information associated with the projects, such as the status of the projects, the lead submission persons of the project, and the assigned reviewers of the projects. From the submission dashboard, the reviewer may also review details of a project by clicking a “Details” button 412 that may include a hyperlink to navigate to a submission detail page on a lower level (e.g., project level) of a multi-level hierarchical structure of submission data.

FIG. 4C illustrates an example of a user interface 420 that shows an example of details of a project according to certain embodiments. User interface 420 shows an example of a project level of a multi-level hierarchical structure of data submitted and stored in the regulatory approval submission and review system. From user interface 420, the reviewer may review general information and milestones of the project, deliverables, correspondence and history, resources, and the like. The reviewer may also create new deliverables, submit review decision, and the like, using user interface 420. User interface 420 also shows various sections of the submission data of a project, such as regulatory affairs, clinical, sterilization, biocompatibility, device description, device fabrication, human factors, labeling, marketing, research and development, risk management sections, and the like. The submission type (e.g., pre-submission), category, regulatory agency reviewer, review due date, completion date, health (status) of the review, and the like of each section may be provided, and a link to the details of each section may also be provided (e.g., via a corresponding button 422 that may include a hyperlink) such that the reviewer may review each section in detail.

As illustrated by FIGS. 3D and 4C, elements such as sections or components of a project may be individually assigned to different reviewers, and the status of the review of each element may be clearly indicated. Therefore, the regulatory agency using the regulatory approval submission and review system disclosed herein may have better visibility to workload for better resource planning and project administration.

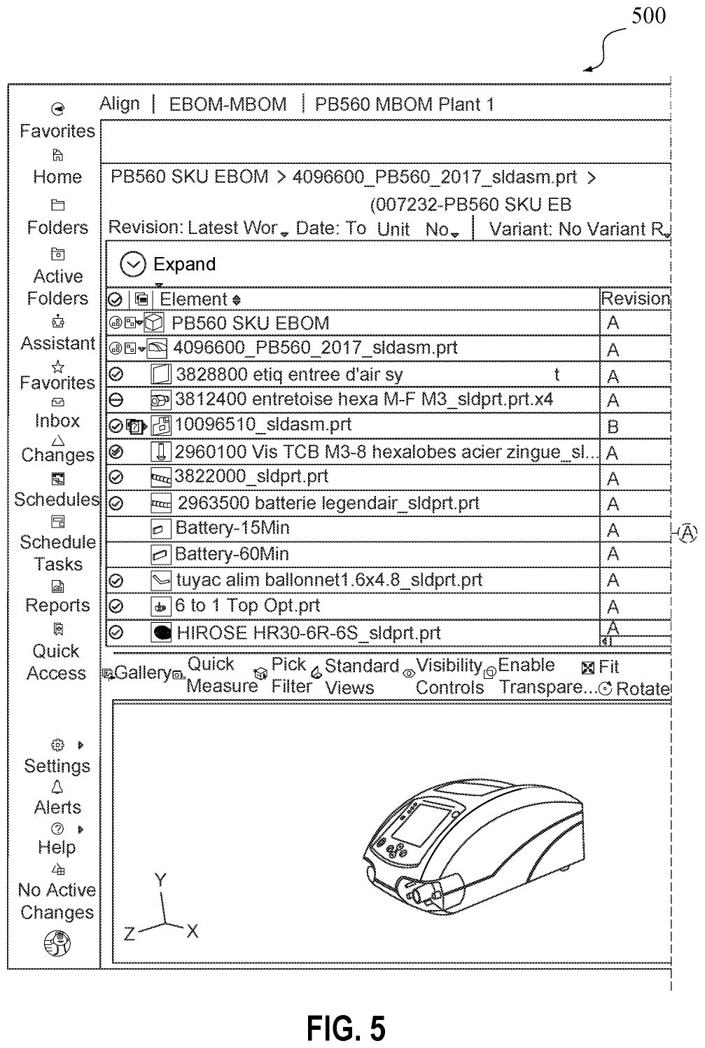

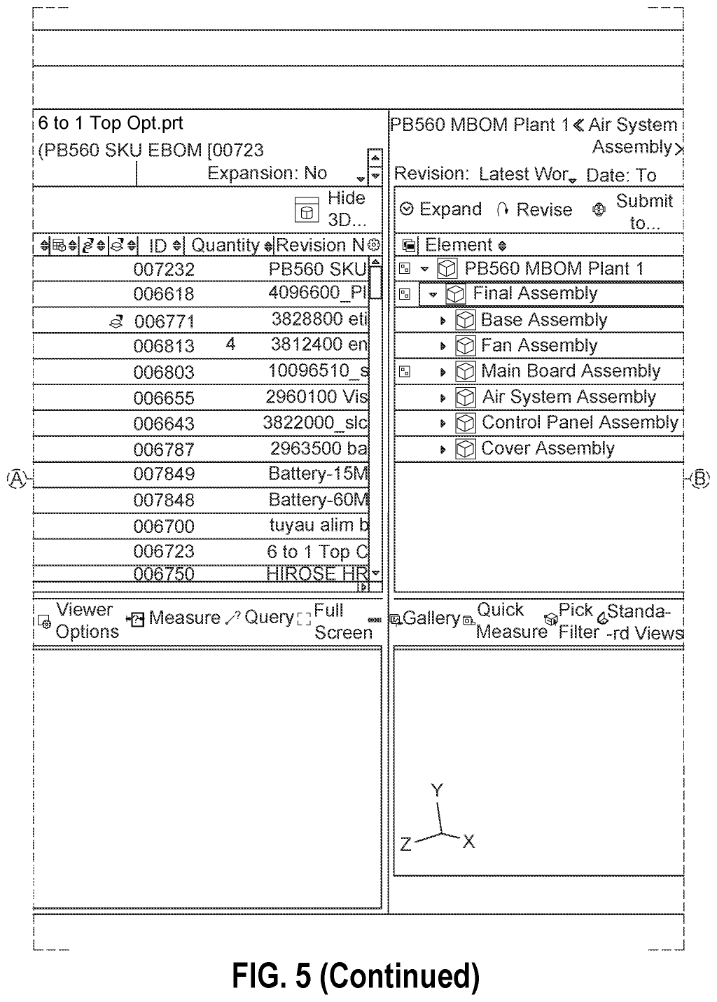

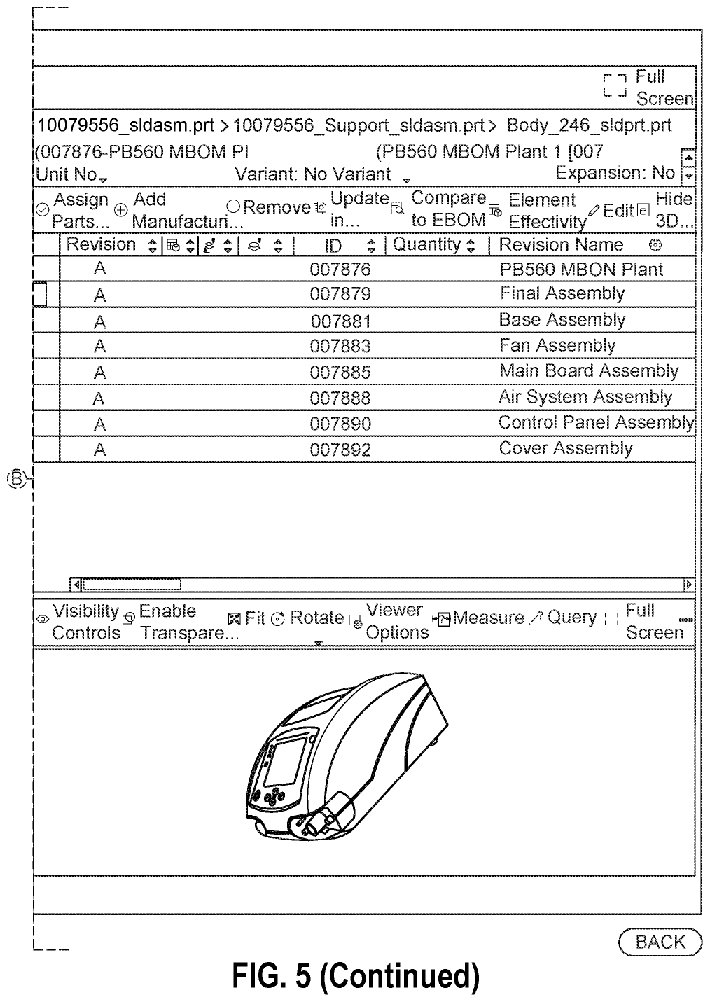

FIG. 5 illustrates an example of a user interface 500 showing an example of a device description section of a submitted project according to some embodiments. In the illustrated example, the engineering bill of materials (EBOM) and the manufacture bill of materials (MBOM) of a medical device are shown side by side. Each bill of materials may list the elements, components, parts, sub-assemblies, assemblies, and the like of the medical device, and the corresponding identification numbers, quantities, revisions, and the like. As illustrated in FIG. 5, the device description may have a multi-level hierarchical structure that includes multiple assemblies and/or subassemblies, where each assembly or subassembly may include multiple components or parts. 2D or 3D views of the medical device or the selected assemblies/components of the medical device may also be shown under the EBOM or MBOM. For example, when a component in the bill of materials is selected, the 3D structure of the selected component may be shown in the 3D view window. A user or reviewer may change the view of the medical device or selected component by dragging, rotating, or otherwise manipulating the medical device or the selected component. When an additional component is selected, the 3D structure of the additional component may be added to the 3D view window. When multiple components are selected, an assembly of the multiple selected components or the relative positions of the multiple selected components in the medical device may be shown. As illustrated, a user or reviewer may choose a view from different views (e.g., standard view, exploded view, or transparent/see-through view) of the medical device or selected components. In some embodiments, the user or reviewer may also measure dimensions of the medical device or selected components. In some embodiments, one or more video clips may be included in the device description section.

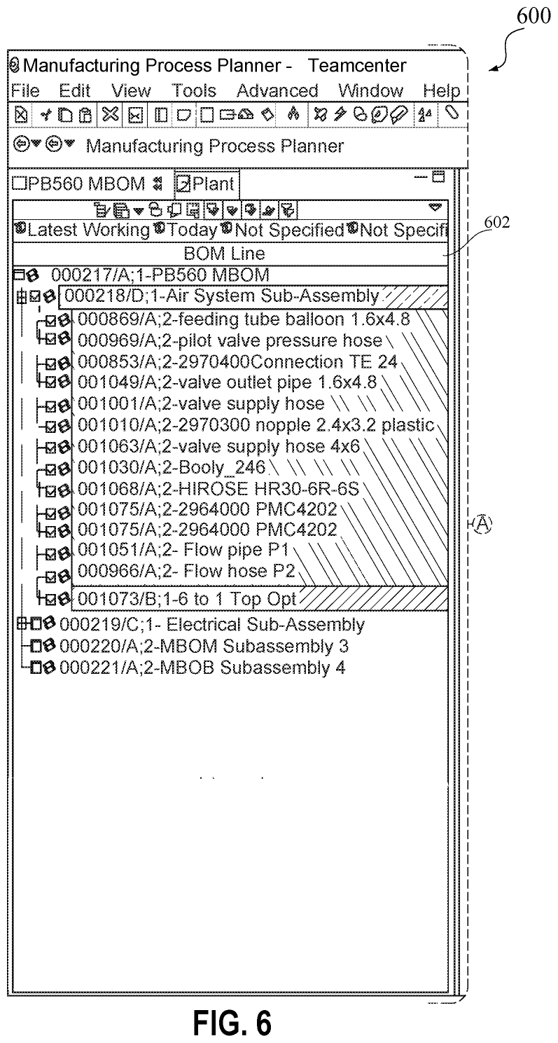

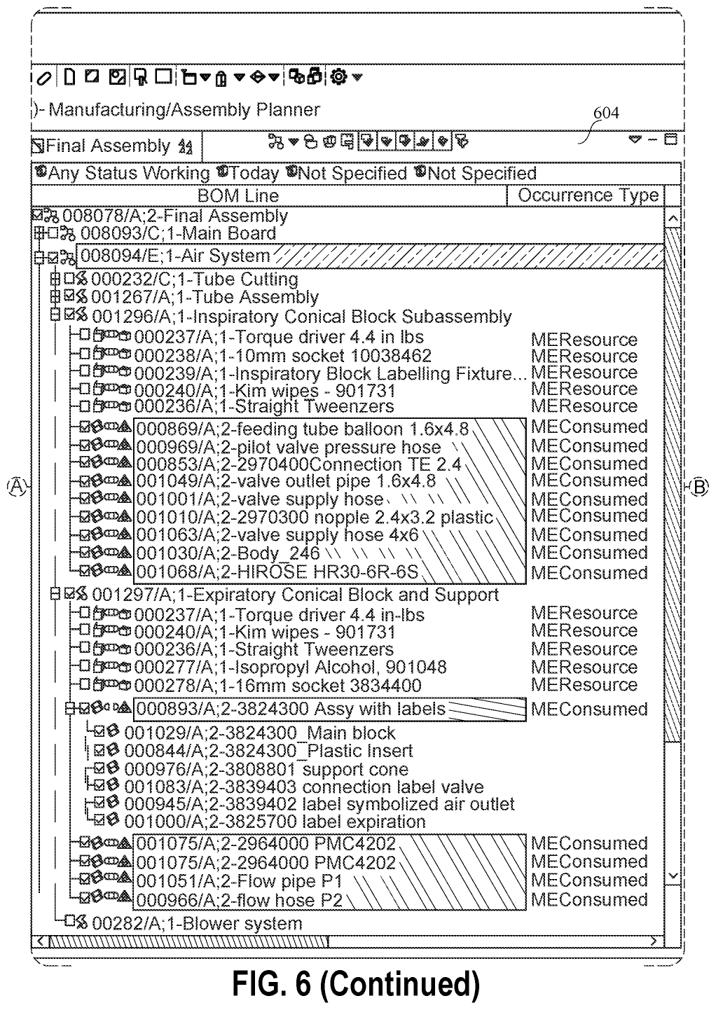

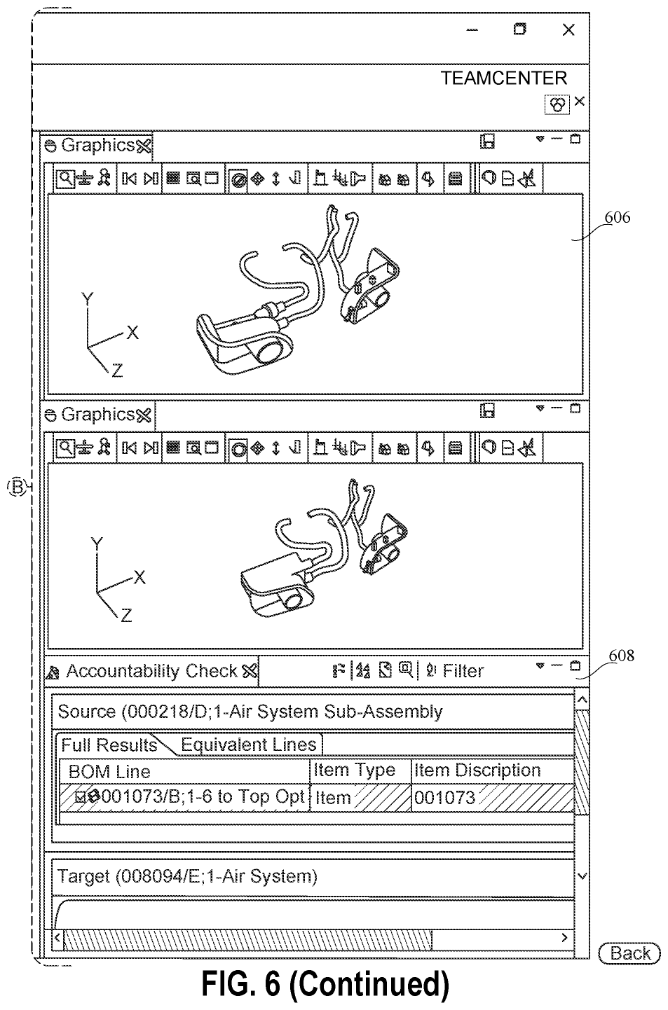

FIG. 6 illustrates an example of a user interface 600 showing a manufacturing process planner section of the submitted project for the medical device shown in FIG. 5 according to certain embodiments. In the illustrated example, user interface 600 may include an MBOM window 602, a final assembly window 604, one or more graphics windows 606, an accountability check window 608, and the like. MBOM window 602 may show sub-assemblies of the medical device in the bill of materials, where the view of each sub-assembly may be expanded to show components or parts in each sub-assembly. In MBOM window 602, sub-assemblies and components that have been modified may be clearly indicated, for example, using a specific color (e.g., yellow or green) or shade. In addition, sub-assemblies and components that have been added may be clearly indicated, for example, using a specific color (e.g., red or yellow) or shade.

Final assembly window 604 may show sub-assemblies of the medical device, where the view of each sub-assembly may be expanded to show components or parts in each sub-assembly. In addition, final assembly window 604 may show steps of manufacturing, such as the cutting or assembly process. In some embodiments, final assembly window 604 may also show the tools or equipment used for the manufacturing. In final assembly window 604, sub-assemblies, components, and processes that have been modified may be clearly indicated, for example, using a specific color (e.g., yellow or green) or shade. In addition, sub-assemblies, components, and processes that have been added may be clearly indicated, for example, using a specific color (e.g., red or yellow) or shade.

One or more graphics windows 606 may show a sub-assembly or component of the medical device. In the illustrated example, graphics windows 606 may show different versions (e.g., an original version and a revised version) of a sub-assembly or component. The accountability check window 608 may show results of accountability check, such as highlighting a newly added component using a specific color (e.g., red or yellow) or shade.

As shown by FIGS. 3D-6, using the regulatory approval submission and review system disclosed herein, users may easily navigate to individual elements (e.g., sections, issues, or components) of the project, and may make comments and changes to the individual elements. For example, the regulatory agency may be able to drill down to the detail of a particular component in the bill-of-material (BOM) or a particular step of the fabrication or application process of a medical device, and make comments on specific deficiency of the particular component or step. In some embodiments, at least some comments, modifications, questions, decisions, and other feedback may be saved as metadata associated with the submission data. The medical product company may also be able to drill down to the detail of the particular component or step, and provide response or update for only the particular component or step, rather than resubmitting the whole regulatory approval submission package. In some embodiments, some responses and updates may be at least partially saved as metadata associated with the submission data. The comments, responses, updates, modifications, and other feedback during the review process may be clearly indicated (e.g., color coded, marked, highlighted, or otherwise indicated), such that the receiving party may focus the review/response on the updates and changes. Since the regulatory agency and the medical product company using the regulatory approval submission and review system disclosed herein can comment on or modify specific elements of the common set of submission data and metadata electronically and interactively during the regulatory approval process, responses or updates regarding the specific elements can be provided by the other party with minimum delay. Incomplete projects, incomplete sections of a project, and/or incomplete review of specific components/steps can be easily identified to gain more attentions of the users. As such, efficiency may be improved and review time may be reduced.

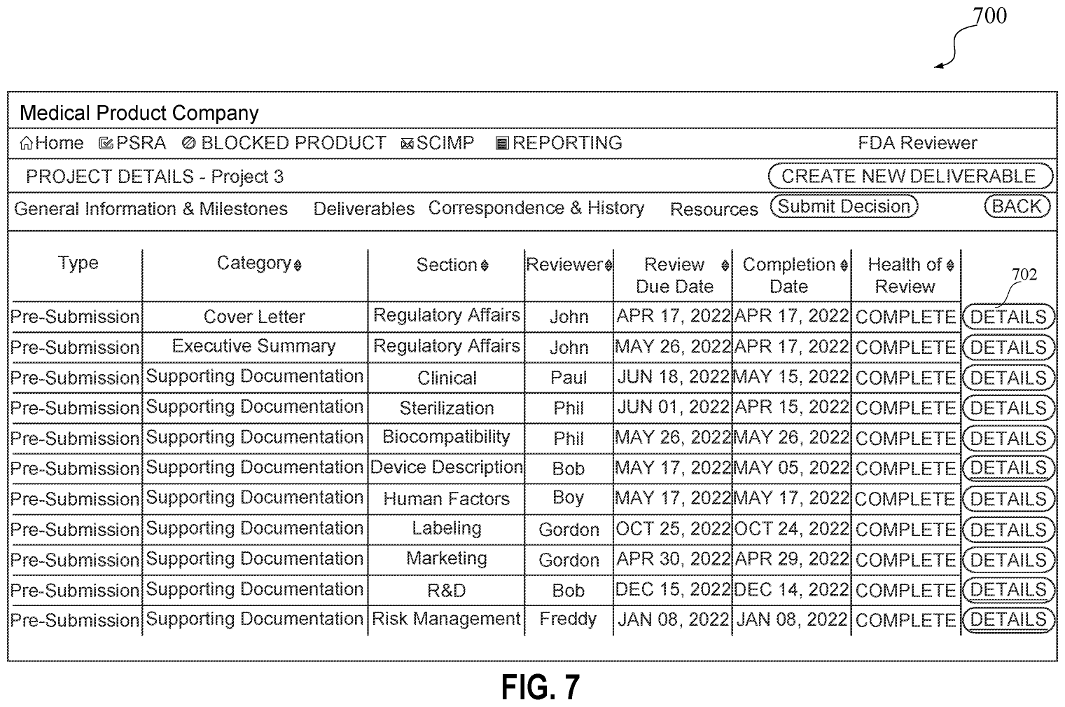

FIG. 7 illustrates an example of a user interface 700 showing a completed project according to certain embodiments. User interface 700 may be an example of a user interface for a regulatory agency or a medical product company. User interface 700 may be similar to user interface 420 that shows an incomplete project. In the example illustrated in FIG. 7, all sections of the project have been reviewed. Details of each section may be reviewed by clicking a corresponding button 702 and navigating through the multiple hierarchical levels.

In some implementations, the regulatory approval submission and review system disclosed herein may also be used by a medical product company to manage a development project, collect data of the project before submission, and the like. In one example, the regulatory approval submission and review system may be used by the medical product company for risk management, such as performing risk analysis, generating impact analysis chart, generating the risk management section of the submission data for a project, and the like.

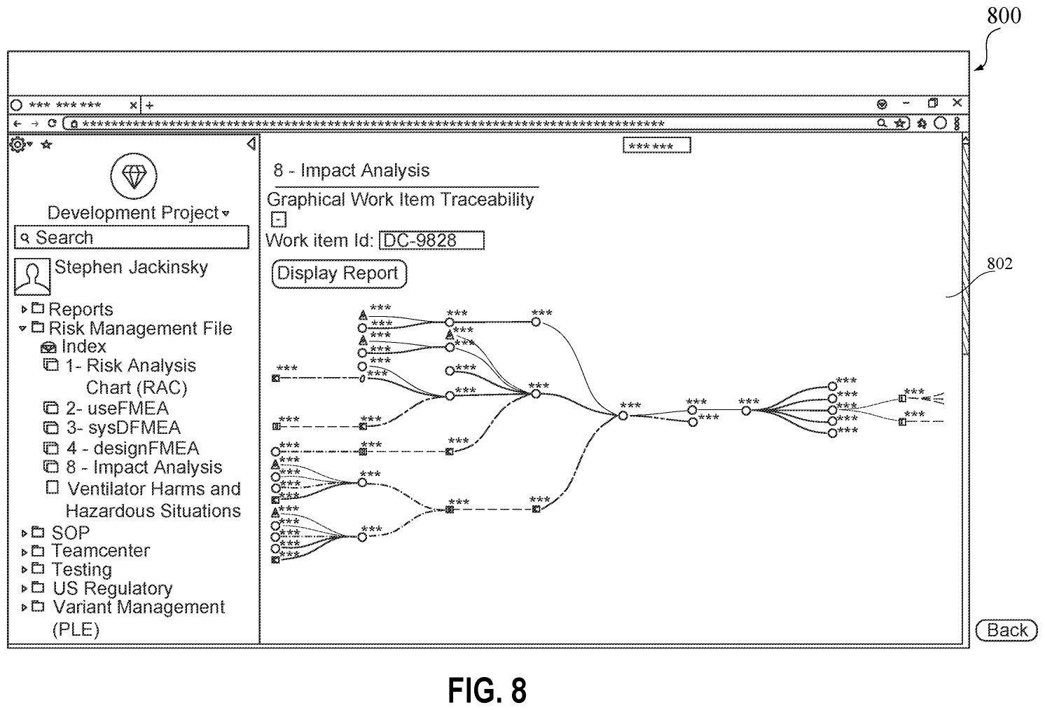

FIG. 8 illustrates an example of a user interface 800 showing an example of end-to-end risk management with links to more details of potential risks of a project according to certain embodiments. The example shown in user interface 800 may be a part of the risk management of a development project, or may be an impact analysis part of a risk management section of the submission data for a project. In the illustrated example, various risks of the project and impact of the risks may be shown in a graph 802 in user interface 800. The relationship between the risks may be shown by connections between the risks in the graph. In some embodiments, the levels of impact of the risks may be indicated by, for example, different colors. Hyperlinks to individual risks may be included in the graph, so that it may be easy for a reviewer to review details and impact of any given risk.

As described above, repository 110 and/or portal 120 may not only provide user interfaces for medical product companies and regulatory agencies, but also host or support other applications or engines. For example, the regulatory approval submission and review system may include built-in functions for evaluating product release, generating analysis results and reports, automatic reporting, automatic generation of emails and notifications, automatic data and/or format validation, project administration, resource management, and the like. In one example, agency dashboard application 160 may generate analysis results or reports and present the analysis results or reports in an agency dashboard through portal 120 and agency submission review user interface 140, whereas medical product company dashboard application 150 may generate analysis results or reports and present the analysis results or reports in a medical product company dashboard through portal 120 and medical product company submission user interface 130.

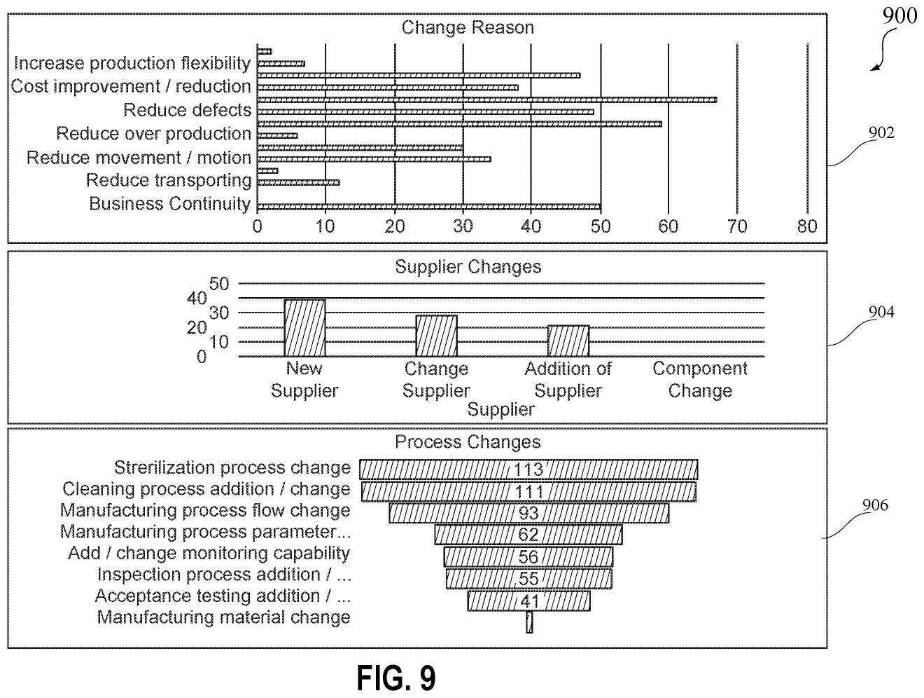

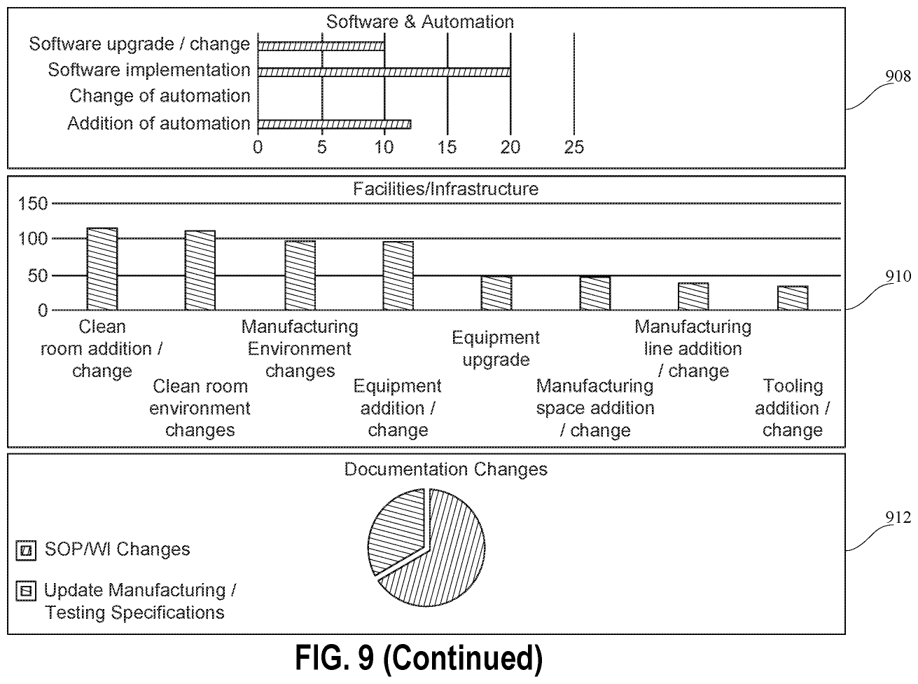

FIG. 9 illustrates an example of a dashboard 900 according to certain embodiments. Dashboard 900 may be an example of a dashboard for a regulatory agency or for a medical product company. In the illustrated example, dashboard 900 shows various statistical data of changes made in one or more projects. For example, a chart 902 in dashboard 900 shows the numbers of changes made for different types of reasons. A chart 904 shows statistical data regarding changes to the suppliers or components. A chart 906 shows the numbers of changes made to different types of processes. A chart 908 shows numbers of changes for different types of software and automation changes. A chart 910 shows numbers of changes for different types of facility or infrastructure changes. A chart 912 shows the ratios of different types of documentation changes. Other statistical data or analysis results may also be shown on dashboard 900 in other embodiments.

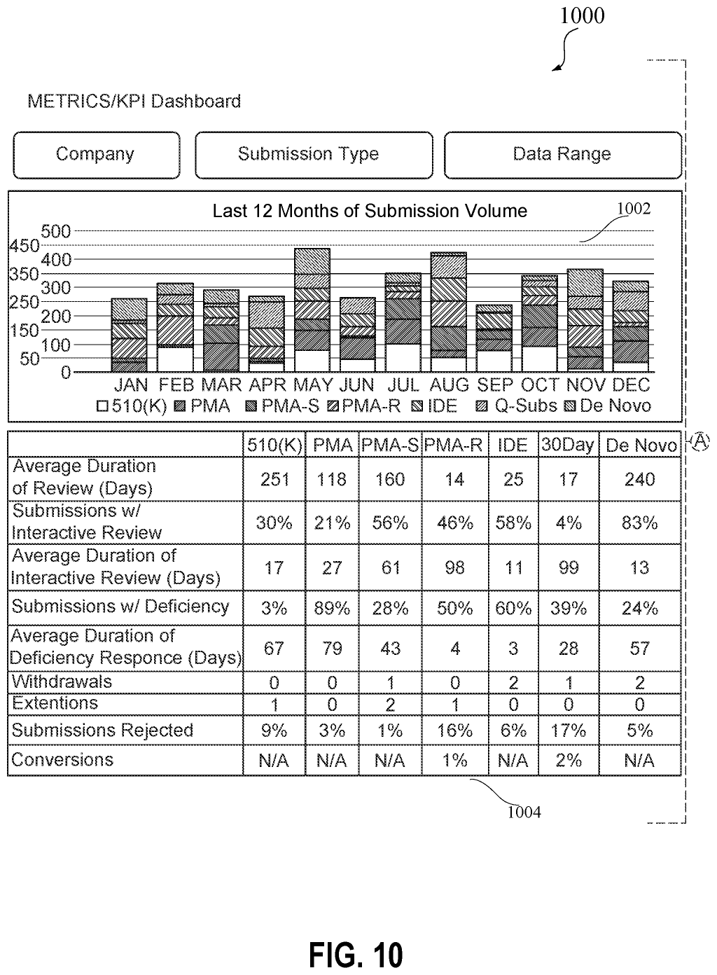

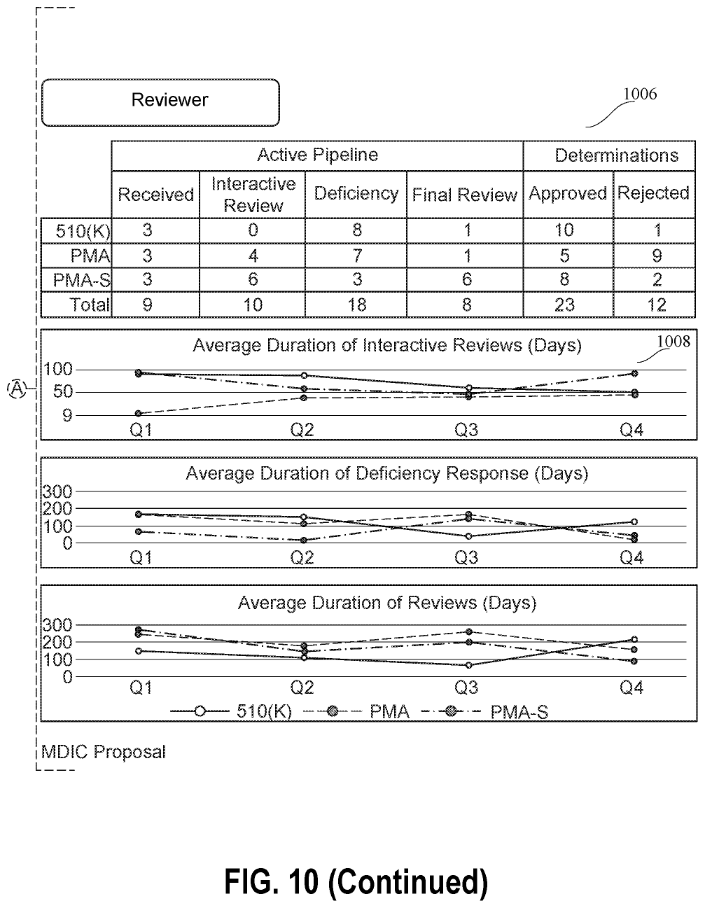

FIG. 10 illustrates another example of a dashboard 1000 according to certain embodiments. Dashboard 1000 may be an example of a dashboard for a regulatory agency or for a medical product company. In the illustrated example, dashboard 1000 shows various metrics or KPIs of projects submitted by one or more medical product companies. For example, a chart 1002 shows the submission volume by a medical product company in each month in different submission types. A table 1004 shows statistical data, such as the average duration of the reviews, the percentage of submissions with interactive review, the average duration of the interactive reviews, the percentage of submissions with deficiencies, the average duration of deficiency responses, the number of withdrawn submissions, the number of rejected submissions, and the like, for different types of submissions. A table 1006 shows the numbers of active submissions (in different review stages) and complete submissions (including approved and rejected submissions), for different types of submissions. Charts 1008 show the average duration of interactive reviews, the average duration of deficiency responses, and the average duration of all reviews, for different types of submissions. It is noted that the metrics or KPIs of the submissions shown in FIG. 10 are only some examples of the metrics and KPIs that may be provided on dashboard 1000. In other embodiments, different metrics and KPIs may be provided on dashboard 1000.

As described above, the access to different contents of the common set of submission data and metadata may be controlled (e.g., filtered) by a portal (e.g., portal 120) of the regulatory approval submission and review system, where different entities may have access to different subsets of data and/or metadata through user dashboard. The portal of the regulatory approval submission and review system may implement various control and filtering mechanisms. For example, some subsets of submission data or metadata may only be accessible by the medical product company, some subsets of submission data or metadata may only be accessible by the regulatory agency, while some subsets of submission data or metadata may be accessible by both the regulatory agency and the medical product company. In some embodiments, the subsets of submission data or metadata that may only be accessible by the medical product company, the subsets of submission data or metadata that may only be accessible by the regulatory agency, and the subsets of submission data or metadata that may be accessible by both the regulatory agency and the medical product company may be stored together, and may be selected or filtered by the portal based on user account information when providing data to the user interface or receiving data from the user interface. In some embodiments, the subsets of submission data or metadata that may only be accessible by the medical product company may be stored in a storage region separate from the storage region for the subsets of submission data or metadata that may only be accessible by the regulatory agency, and the storage region for the subsets of submission data or metadata that may be accessible by both the regulatory agency and the medical product company, where the portal may grant user access to different storage regions based on user account information.

In some implementations, the access to different contents of the common set of submission data and metadata may be controlled (e.g., filtered) based on at least the roles of the users of the regulatory approval submission and review system. For example, a user may need to be authorized (e.g., using user name and password) and authenticated (e.g., using biometric information or a user challenge, such as CAPTCHA) first in order to access the regulatory approval submission and review system, where the user authorization and authentication may be implemented by the portal based on information stored in a user (or group) account database. The user account database may store, for example, the user name, password, biometric information, organization, user group, role, access right, and/or other attributes associated with each user account, which may be specified by, for example, a system administrator. The user account information may specify the type (or other attributes) of the data that can be accessed (read and/or write) by a particular user or user group, and/or may specify the type (or other attributes) of the data that cannot be accessed (read and/or write) by a particular user or user group. Thus, the portal may control the access to the data by a particular user or user group based on the access right specified in the user account information.

In some implementations, different team members of the regulatory agency or the medical product company with different responsibilities or job functions may be in different user groups and may have access to different subsets of biometric data or metadata. In some implementations, the dashboard, key performance indicators (KPIs), metrics, and other analysis results or reports (e.g., risk or impact analysis results) may be generated and accessible based on user roles or user account information. For example, the results shown on dashboard 900 may be different for different users having different roles or job functions, and the metrics and KPIs shown on dashboard 1000 may be different for different users having different roles or job functions.

In one implementation, when making a comment or creating other metadata, a user may indicate (e.g., by making a selection) whether the metadata belongs to a common (public) subset of metadata or one or more internal (private) subsets of metadata, such that the portal may filter the common set of submission data and metadata based on the indication and a user's role (e.g., user account or user group) to show only comments intended to be viewable by the user. For example, the portal may filter the metadata, such that a regulatory agency expert may be able to review the common (public) subset of metadata and one or more internal (private) subsets of metadata of the regulatory agency (but not one or more internal subsets of metadata of the medical product company). Similarly, the portal may filter the metadata in the common set of submission data and metadata, such that a user from the medical product company may be able to review the common subset of metadata and the one or more internal subsets of metadata of the medical product company (but not the one or more internal subsets of metadata of the regulatory agency).

In some embodiments, the medical product company may build knowledgebases based on the comments or other feedback from the regulatory agency and/or progress and results of the review. For example, the comments/feedback may be categorized and can be searchable in the knowledgebase based on, for example, project name, keyword, country/region, reviewer, submitter, etc. The medical product company may learn from the knowledgebase such that future submissions can have higher quality, the number of iterations/revisions can be reduced, and the review process can be shorter. In some embodiments, electronic manuals may be automatically generated based on the common set of submission data and metadata, and may be automatically updated based on the comments and the responses (e.g., changes or updates made to the product). In some embodiments, the regulatory approval submission and review system may include built-in logic or functions for evaluating product release, automatic reporting functionality, automatic generation of emails and notifications, automatic data and/or format validation, project administration, resource management, and the like.

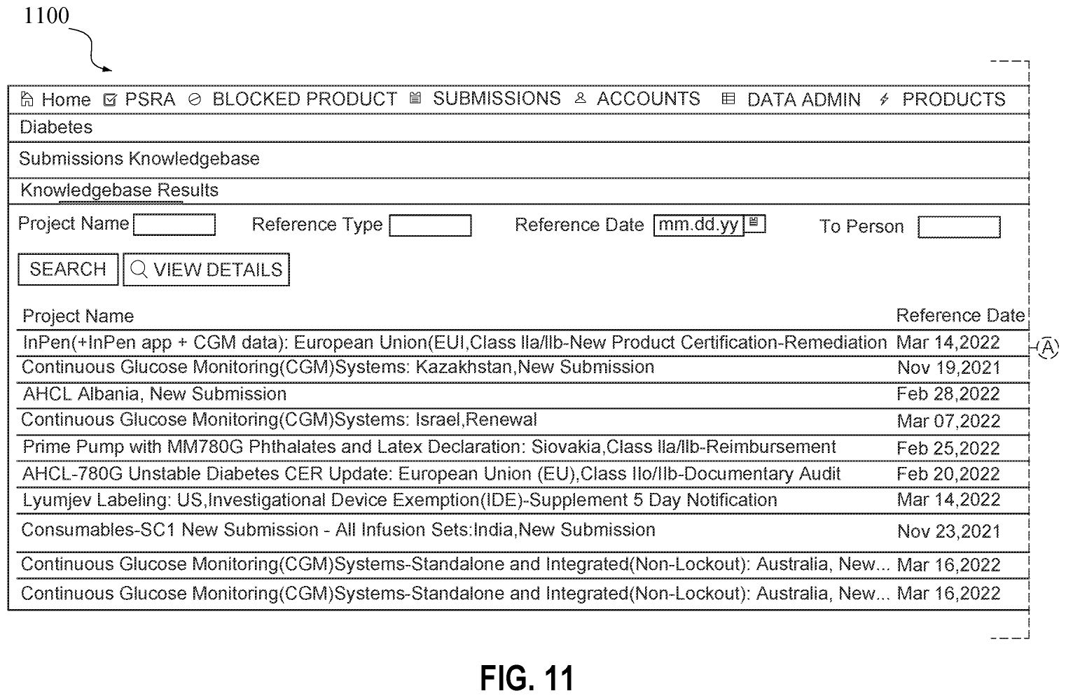

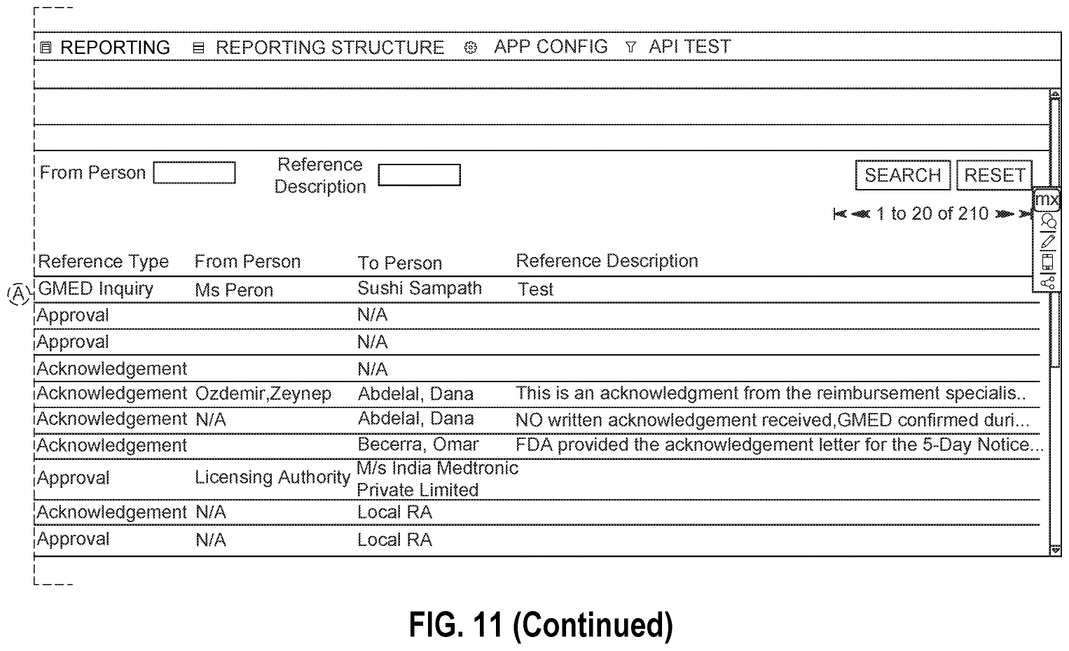

FIG. 11 illustrates an example of a medical product company knowledgebase 1100 generated using the regulatory approval submission and review system disclosed herein according to some embodiments. Medical product company knowledgebase 1100 may provide various knowledge regarding the regulatory approval submission and review process learned from current and past submissions, such that a submitter may prepare submissions and responses with higher quality to reduce the number of iterations/revisions, thereby reducing the duration of the review process. As described above, the knowledgebase may include, for example, feedback from the regulatory agency, correspondence with the regulatory agency, internal communications of the medical product company, and the like. In some implementations, information in the knowledgebase may be categorized (e.g., automatically or manually when the information is created or after receiving the information), and may be searchable based on, for example, project name, keyword, short description, country, agency, reviewer, submitter, receiver, submission section, reference type (e.g., inquiry, acknowledgement, or approval), date, and the like. In the example illustrated in FIG. 11, the knowledge may by default be provided based on the corresponding projects, and may be searched or filtered by, for example, the project name, reference type, reference date, sender, recipient, reference description, and the like.

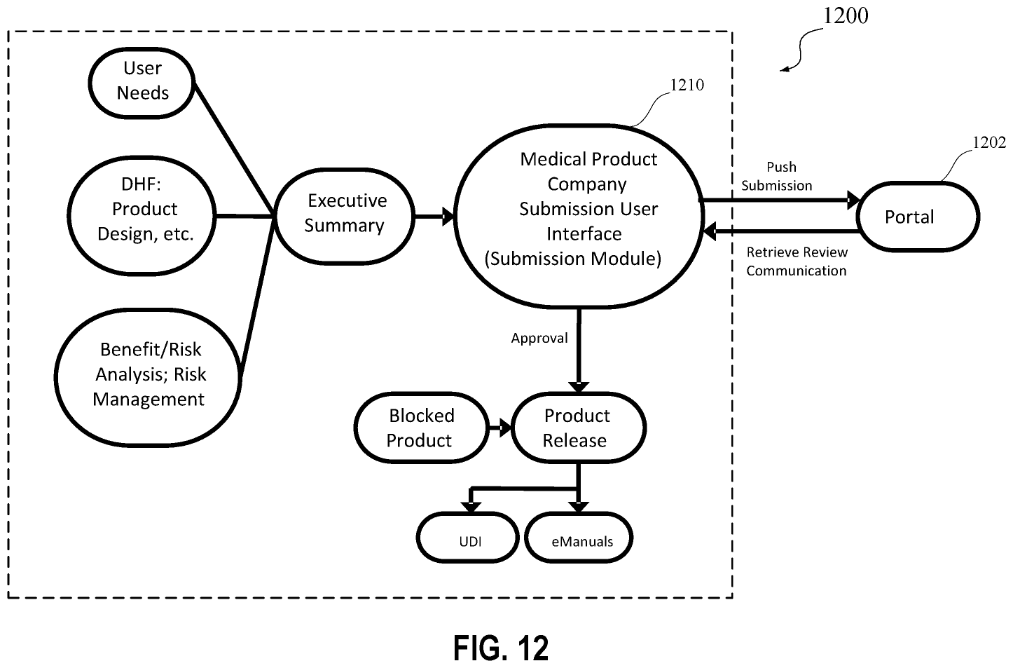

FIG. 12 illustrates an example of using the regulatory approval submission and review system disclosed herein by a medical product company to perform other functions according to certain embodiments. In the illustrated example, a system 1200 of the medical product company may be communicatively coupled to a portal 1202 of a regulatory approval submission and review system disclosed herein. System 1200 may include a user interface 1210 that may, in combination with portal 1202, implement a submission module for the medical product company. In some embodiments, user interface 1210 may be similar to medical product company submission user interface 130. In some embodiments, user interface 1210 may provide, to the medical product company, guidance for collecting or generating submission data for regulatory approval. The submission data may include data related to user needs, design history, product design, device description, sterilization, biocompatibility, benefit/risk analysis, risk management, and the like, for a medical product. The collected or generated submission data may include artifacts or other supporting data in various formats, such as documents, images, design files, videos, audios, other multimedia content, and the like. In some embodiments, an executive summary for the submission may be generated based on the collected or generated submission data, manually or automatically using the submission module. The medical product company may upload the created submission data that includes the executive summary, the artifacts, and other supporting data to the regulatory approval submission and review system through user interface 1210 and portal 1202, to create a set of submission data for the product as described above. In some embodiments, user interface 1210 and portal 1202 may perform a format validation of the submission data.

In some embodiments, system 1200 may, upon receiving approval from the regulatory agency, perform certain functions for product release if the product is not in a blocked product list. For example, system 1200 may generate electronic user manuals based on the submission data, and/or may update the electronic user manuals based on changes made to the submission data during the review process or the final approved submission data. In one example, a component of the product may be modified or a new component may be added to the product by the medical product company in response to feedback from the regulatory agency during the review process, and an electronic user manual may be updated to reflect the changes to the medical product after the submission is approved. In some embodiments, system 1200 may, based on the approved submission data, generate information related to unique device identification (UDI) for the medical product, which may then be submitted to an accredited agency responsible for issuing unique device identifiers (e.g., Global Unique Device Identification Database (GUDID)) to obtain a unique device identifier. Other information may also be generated as needed by system 1200 based on the approved submission data.

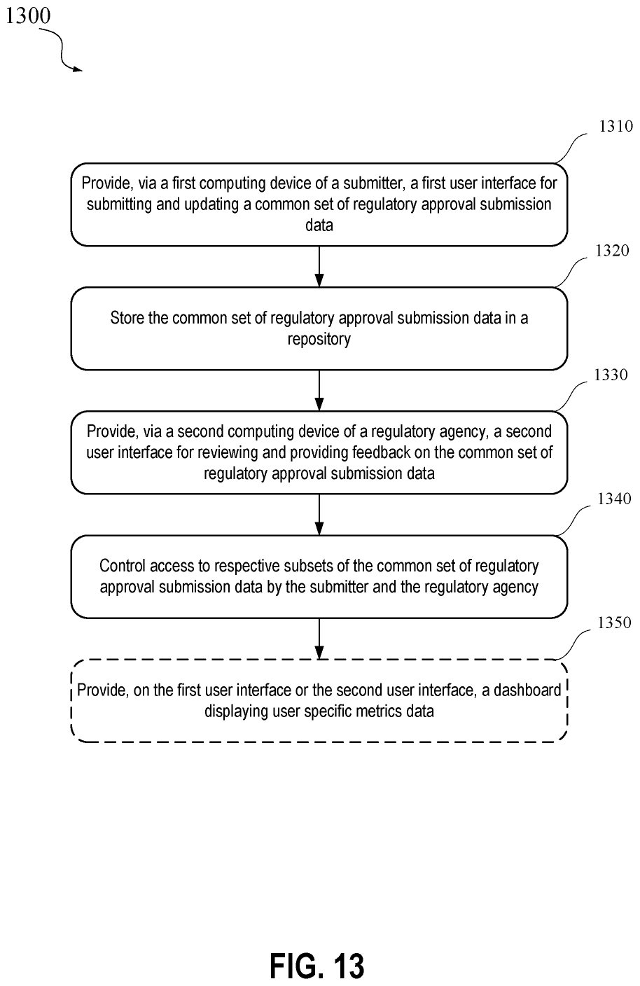

FIG. 13 includes a flowchart 1300 illustrating examples of operations that may be performed by the regulatory approval submission and review system (e.g., a portal and/or a repository of the regulatory approval submission and review system) disclosed herein according to certain embodiments. Operations in flowchart 1300 may be performed by, for example, one or more servers or other computing systems (e.g., a computing system 1500 described below). Although flowchart 1300 may describe the operations as a sequential order, some of the operations may be performed in parallel or concurrently. In addition, the order of the operations may be rearranged. The process may have additional steps not included in the flowchart. Some operations may be optional or may be omitted in some implementations. Some operations may be performed more than one time.

In the example illustrated in FIG. 13, the operations in flowchart 1300 may include, at block 1310, providing, by a portal of a regulatory approval submission and review system via a first computing device of a submitter (e.g., a medical product company), a first user interface for submitting and updating a common set of regulatory approval submission data. As described above, a medical product company may submit data related to a medical product in the common set of regulatory approval submission data to the regulatory approval submission and review system via the first user interface and the portal. The common set of regulatory approval submission data may include, for example, executive summary, artifacts, and supporting data, and may include one or more documents, one or more design files, video content, audio content, multimedia content, or a combination thereof. In some embodiments, the common set of regulatory approval submission data may also include metadata. In some embodiments, the metadata may be included in the corresponding elements (e.g., projects, sections, subassemblies, components, steps, etc.) of the common set of regulatory approval submission data. In some embodiments, the first user interface may enable a user to change views of a medical device, a subassembly of the medical device, or a component of the subassembly of the medical device, and/or may enable a user to compare at least two versions of a medical device, a subassembly of the medical device, or a component of the subassembly of the medical device. The first user interface may enable a user to review or modify individual sections of the common set of regulatory approval submission data. In some embodiments, modified sections of the common set of regulatory approval submission data may be highlighted in the first user interface.

Operations at block 1320 may include storing the common set of regulatory approval submission data in a repository. In some embodiments, the common set of regulatory approval submission data may be stored in the repository in a multi-level hierarchical structure such that a user may navigate to specific elements of the common set of regulatory approval submission data according to the multi-level hierarchical structure to review or modify the specific elements. The multi-level hierarchical structure may include, for example, a project level, a section level below the project level, an assembly or subassembly level below the section level, and a component level below the assembly level. Elements of the common set of regulatory approval submission data stored in the repository may be be individually added or modified by the submitter or the regulatory agency. Modifying the elements of the common set of regulatory approval submission data individually may include adding or modifying metadata associated with individual elements of the common set of regulatory approval submission data. In some embodiments, notification may be sent to a regulatory agency after the common set of regulatory approval submission data is submitted and stored in the repository. In some embodiments, the common set of regulatory approval submission data may include a subset of public data that is accessible by the submitter and the regulatory agency, one or more subsets of private data that are only accessible by the submitter, and one or more subsets of private data that are only accessible by the regulatory agency.

Operations at block 1330 may include providing, by the portal via a second computing device of a regulatory agency, a second user interface for reviewing and providing feedback on the common set of regulatory approval submission data. The second user interface may enable the regulatory agency to navigate to specific elements of the common set of regulatory approval submission data according to the multi-level hierarchical structure. In some embodiments, the elements of the common set of regulatory approval submission data may be individually assigned to two or more experts of the regulatory agency for review. The regulatory agency may comment or otherwise provide feedback on individual elements of the common set of regulatory approval submission data. In some embodiments, the comments or other feedback may be saved as metadata associated with corresponding elements of the common set of regulatory approval submission data. In some embodiments, elements of the common set of regulatory approval submission data modified by the submitter or the regulatory agency may be highlighted in the second user interface. In some embodiments, the second user interface may enable a user to change views of a medical device, a subassembly of the medical device, or a component of the subassembly of the medical device, and/or may enable a user to compare at least two versions of a medical device, a subassembly of the medical device, or a component of the subassembly of the medical device. In some embodiments, notification may be sent to the submitter through the first user interface after one or more elements of the common set of regulatory approval submission data have been reviewed by the regulatory agency so that the submitter may start to respond to the feedback regarding the one or more elements as soon as possible.

Operations at block 1340 may include controlling access to respective subsets of the common set of regulatory approval submission data by the submitter and the regulatory agency. For example, the submitter may be allowed to access a subset of public data that is accessible by the submitter and the regulatory agency and one or more subsets of private data that are only accessible by the submitter, while the regulatory agency may be allowed to access the subset of public data that is accessible by the submitter and the regulatory agency and one or more subsets of private data that are only accessible by the regulatory agency. In some embodiments, different users of the submitter may have access to different subsets of the common set of regulatory approval submission data, or different users of the regulatory agency may have access to different subsets of the common set of regulatory approval submission data. In some embodiments, the portal may filter the data provided to the first user interface or the second user interface based at least partially on metadata associated with the elements of the common set of regulatory approval submission data.

In some embodiments, the operations in flowchart 1300 may also include, at block 1350, providing, on the first user interface or the second user interface, a dashboard displaying user specific metrics data. The user specific metrics data may include various statistical data or performance indicators generated based on a user's role. In some embodiments, the portal may provide, via the first user interface or the second user interface, other information to the submitter or the regulatory agency, such as a reviewer, a status, and an expected completion data of a given element (e.g., section) of the common set of regulatory approval submission data. In some embodiments, the portal may provide, to the first user interface or the second user interface, a risk analysis graph that includes at least one link to details of a risk associated with a product for approval by the regulatory agency.

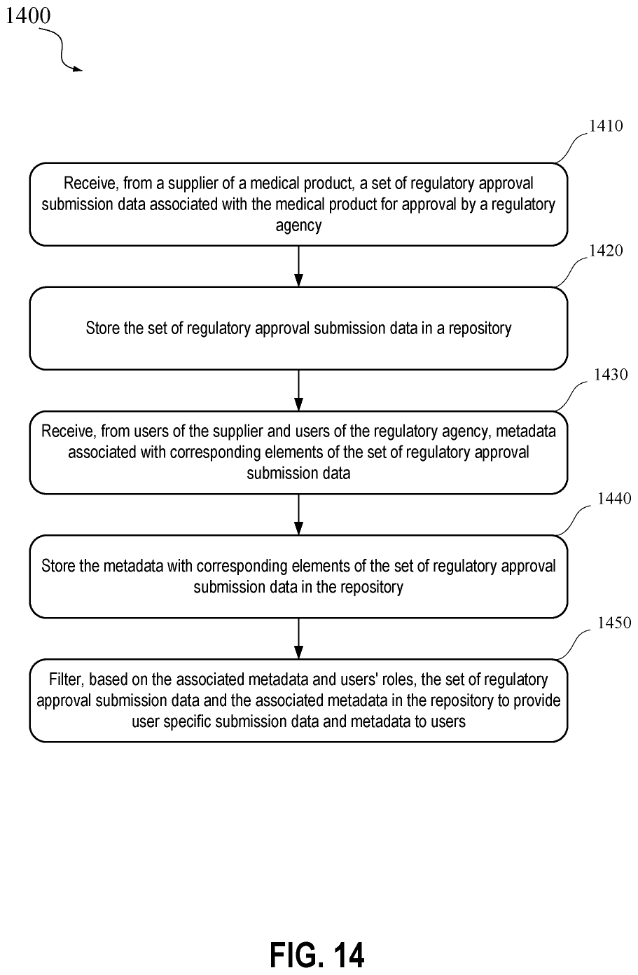

FIG. 14 includes a flowchart 1400 illustrating examples of operations that may be performed by the regulatory approval submission and review system (e.g., a portal and/or a repository of the regulatory approval submission and review system) disclosed herein according to certain embodiments. Operations in flowchart 1400 may be performed using, for example, one or more servers or other computing systems (e.g., a computing system 1500 described below). Although flowchart 1400 may describe the operations as a sequential order, some of the operations may be performed in parallel or concurrently. In addition, the order of the operations may be rearranged. The process may have additional steps not included in the flowchart. Some operations may be optional or may be omitted in some implementations. Some operations may be performed more than one time.

In the example illustrated in FIG. 14, the operations in flowchart 1400 may include, at block 1410, receiving, from a supplier of a medical product, a set of regulatory approval submission data associated with the medical product for approval by a regulatory agency. The set of regulatory approval submission data may include a plurality of elements, and may include one or more documents, one or more design files, video content, audio content, multimedia content, or a combination thereof.

Operations at block 1420 may include storing the set of regulatory approval submission data in a repository. In some embodiments, the set of regulatory approval submission data may be stored in the repository according to a multi-level hierarchical structure. The multi-level hierarchical structure may include, for example, a project level, a section level below the project level, an assembly (or subassembly) level below the section level, and/or a component level below the assembly level.

Operations at block 1430 may include receiving, from users of the supplier and users of the regulatory agency, metadata associated with corresponding elements of the set of regulatory approval submission data. The metadata associated with an element of the set of regulatory approval submission data may include an attribute indicating accessibility of the element and/or the metadata associated with the element. The metadata may include, for example, comments, questions, decisions, modifications, revision history, status, or other attributes associated with one or more corresponding individual elements of the set of regulatory approval submission data. In one example, the metadata indicates whether the metadata belongs to a subset of public metadata that is accessible by the regulatory agency and the supplier, a subset of supplier metadata that is accessible by the supplier but are not accessible by the regulatory agency, or a subset of agency metadata that is accessible by the regulatory agency but are not accessible by the supplier. The metadata may be categorized or searchable.

Operations at block 1440 may include storing the metadata with the corresponding elements of the set of regulatory approval submission data in the repository. In some embodiments, the associated metadata is stored with corresponding elements of the set of regulatory approval submission data in the multi-level hierarchical structure.

Operations at block 1450 may include filter, based on the associated metadata and users' roles, the set of regulatory approval submission data and the associated metadata in the repository to provide user specific data and metadata to the users of the supplier and the users of the regulatory agency. In some embodiments, user specific metrics data (e.g., statistical data) may be provided to a dashboard of a user interface based on the associated metadata and the user's role. In some embodiments, a submission knowledgebase may be provided to a user of the supplier of the medical product through a user interface, where the submission knowledgebase may include knowledge regarding a regulatory approval submission and review process learned from pending projects and complete projects. In some embodiments, different data and metadata may be provided to two users of the supplier having different roles or in different user groups.

Embodiments of the methods disclosed herein may be implemented by hardware, software, firmware, middleware, microcode, hardware description languages, or any combination thereof. For example, the operations may be performed by one or more servers or other computer systems. When implemented in software, firmware, middleware, or microcode, the program code or code segments to perform the associated tasks may be stored in one or more computer-readable media such as a storage medium, and may be executed by one or more processors to perform the associated tasks. The computer-readable media may include transitory or non-transitory computer-readable media, such as RAM, ROM, EEPROM, flash memory, solid-state drive, hard drive, CD, DVD, or any other medium that can be used to store desired program code in the form of instructions or data structures and that can be accessed by a computer. The one or more processors may include general purpose microprocessors, application specific integrated circuits (ASICs), graphic processing units (GPUs), network processing units (NPUs), digital signal processors (DSPs), field programmable logic arrays (FPGAs), and the like.

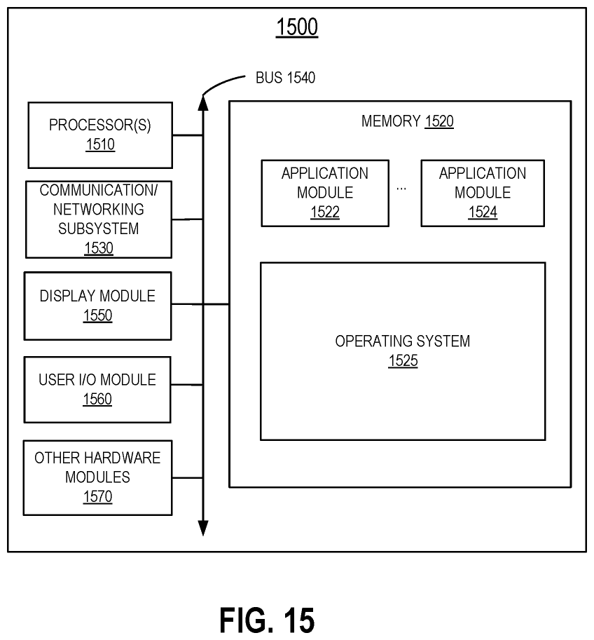

FIG. 15 is a simplified block diagram of an example of a computing system 1500 for implementing some of the examples disclosed herein. It should be noted that FIG. 15 is meant only to provide a generalized illustration of various components, any or all of which may be utilized as appropriate. In addition, it can be noted that components illustrated by FIG. 15 can be localized to a single device and/or distributed among various networked devices, which may be disposed at different geographical locations.

In the illustrated example, computing system 1500 may include one or more processor(s) 1510 and a memory 1520. Processor(s) 1510 may be configured to execute instructions for performing operations at a number of components, and can be, for example, a general-purpose processor or microprocessor suitable for implementation within a portable electronic device. In some embodiments, processor(s) 1510 may include specific-purpose processors, ASICs, GPUs, NPUs, tensor processing units (TPUs), DSPs, FPGAs, systolic arrays, accelerators, and the like. Processor(s) 1510 may be communicatively coupled with a plurality of components within computing system 1500. To realize this communicative coupling, processor(s) 1510 may communicate with the other illustrated components across a bus 1540. Bus 1540 may be any subsystem adapted to transfer data within computing system 1500. Bus 1540 may include a plurality of computer buses and additional circuitry to transfer data.

Memory 1520 may be coupled to processor(s) 1510. In some embodiments, memory 1520 may offer both short-term and long-term storage and may be divided into several units. Memory 1520 may be volatile, such as static random access memory (SRAM) and/or dynamic random access memory (DRAM), and/or non-volatile, such as read-only memory (ROM), flash memory, solid-state drive, and the like. Furthermore, memory 1520 may include removable storage devices, such as secure digital (SD) cards. Memory 1520 may provide storage of computer-readable instructions, data structures, program modules, and other data for computing system 1500. In some embodiments, memory 1520 may be distributed into different hardware modules. A set of instructions and/or code might be stored on memory 1520. The instructions might take the form of executable code that may be executable by computing system 1500, and/or might take the form of source and/or installable code, which, upon compilation and/or installation on computing system 1500 (e.g., using any of a variety of generally available compilers, installation programs, compression/decompression utilities, etc.), may take the form of executable code.

Memory 1520 may include an operating system 1525 loaded therein. Operating system 1525 may be operable to initiate the execution of the instructions provided by application modules 1522-1524 and/or manage other hardware modules 1570, as well as interface with a communication/networking subsystem 1530 which may include one or more wired and/or wireless transceivers. Operating system 1525 may be adapted to perform other operations across the components of computing system 1500 including threading, virtualization, resource management, data storage control, and other similar functionality. In some embodiments, memory 1520 may store a plurality of application modules 1522 through 1524, which may include any number of applications. Examples of the applications may include, for example, medical product company dashboard application 150, agency dashboard application 160, an application for providing medical product company submission user interface 130, an application for providing agency submission review user interface 140, and other applications that users may use. Application modules 1522-1524 may include particular instructions to be executed by processor(s) 1510. In some embodiments, certain applications or parts of application modules 1522-1524 may be executable by other hardware modules 1570. In certain embodiments, memory 1520 may additionally store parameters (e.g., weights) of trained ML models, training data, labeled medical data, unlabeled medical data, user account information, user qualification information, and the like.

Communication/networking subsystem 1530 may include, for example, a modem, a network card (wireless or wired), an infrared communication device, a wireless communication device and/or chipset (such as a Bluetooth® device, an IEEE 802.11 device, a Wi-Fi device, a WiMax device, cellular communication facilities, etc.), and/or similar communication interfaces. In some embodiments, computing system 1500 may include one or more antennas for wireless communication as part of communication/networking subsystem 1530 or as a separate component coupled to any portion of the system. Depending on desired functionality, communication/networking subsystem 1530 may include separate transceivers to communicate with base transceiver stations and other wireless devices and access points, which may include communicating with different data networks and/or network types, such as wide-area networks (“WANs”), wireless wide-area networks (WWANs), local area networks (LANs), wireless local area networks (WLANs), personal area networks (PANs), or wireless personal area networks (WPANs). A WWAN may be, for example, a WiMax (IEEE 802.16) network. A WLAN may be, for example, an IEEE 802.11x network. A WPAN may be, for example, a Bluetooth network, an IEEE 802.15x, or some other types of network. The techniques described herein may also be used for any combination of WAN, LAN, PAN, WWAN, WLAN, and/or WPAN. Communication/networking subsystem 1530 may permit data to be exchanged with a network, other computer systems, and/or any other devices described herein. Communication/networking subsystem 1530 may include a means for transmitting or receiving data, such as text, photos, audios, or videos. Communication/networking subsystem 1530, processor(s) 1510, and memory 1520 may together comprise at least a part of one or more of a means for performing some functions disclosed herein.

Computing system 1500 may include a display module 1550. Display module 1550 may present information, such as text, images, audios, videos, and various instructions, from computing system 1500 to a user. Such information may be derived from one or more application modules 1522-1524, communication/networking subsystem 1530, one or more other hardware modules 1570, a combination thereof, or any other suitable means. For example, display module 1550 may be used to display user challenges that may include text, images, waveforms, audio clips, video clips, and the like. Display module 1550 may use liquid crystal display (LCD) technology, light-emitting diode (LED) technology (including, for example, OLED, ILED, μLED, AMOLED, TOLED, etc.), light emitting polymer display (LPD) technology, or some other display technology.

Computing system 1500 may include a user input/output module 1560. User input/output module 1560 may allow a user to send action requests or provide information to computing system 1500. An action request may be a request to perform a particular action. For example, an action request may be to start or end an application (e.g., accessing a website, an application hosted in the cloud, or a server) or to perform a particular action within the application. User input/output module 1560 may include one or more input devices. Examples of the input devices may include a touchscreen, a touch pad, microphone(s), button(s), dial(s), switch(es), a keyboard, a mouse, a game controller, a fingerprint reader, a camera, or any other suitable device for receiving action requests or information and communicating the received action requests or information to computing system 1500. In some embodiments, user input/output module 1560 may provide feedback (e.g., alerts, alarms, or audios) to the user in accordance with instructions received from computing system 1500. In some embodiments, the camera that may be used to take photos or videos of a user, for example, for user authentication and authorization based on biometric information (e.g., face or iris/retina pattern). The camera may include, for example, a complementary metal-oxide-semiconductor (CMOS) image sensor with a few millions or tens of millions of pixels. In some implementations, the camera may include two or more cameras that may be used to capture 3-D images.

In some embodiments, computing system 1500 may include a plurality of other hardware modules 1570. Each of other hardware modules 1570 may be a physical module within computing system 1500. While each of other hardware modules 1570 may be permanently configured as a structure, some of other hardware modules 1570 may be temporarily configured to perform specific functions or temporarily activated. Examples of other hardware modules 1570 may include, for example, an audio output and/or input module (e.g., a microphone or speaker), a near field communication (NFC) module, a rechargeable battery, a battery management system, a wired/wireless battery charging system, etc. In some embodiments, one or more functions of other hardware modules 1570 may be implemented in software.

In various implementations, the above-described hardware and modules may be implemented on a single device or on multiple devices that can communicate with one another using wired or wireless connections. In alternative configurations, different and/or additional components may be included in computing system 1500. Similarly, functionality of one or more of the components can be distributed among the components in a manner different from the manner described above.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, systems, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing various embodiments. Various changes may be made in the function and arrangement of elements without departing from the spirit and scope of the present disclosure.

Also, some embodiments were described as processes depicted as flow diagrams or block diagrams. Although each may describe the operations as a sequential process, many of the operations may be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

It will be apparent to those skilled in the art that substantial variations may be made in accordance with specific requirements. For example, customized or special-purpose hardware might also be used, and/or particular elements might be implemented in hardware, software (including portable software, such as applets, etc.), or both. Further, connection to other computing devices such as network input/output devices may be employed.

Any of the herein described techniques, operations, methods, programs, algorithms, or codes may be converted to, or expressed in, a programming language or computer program embodied on a computer, processor, or machine-readable medium. The terms “programming language” and “computer program,” as used herein, each include any language used to specify instructions to a computer or processor, and include (but is not limited to) the following languages and their derivatives: Assembler, Basic, Batch files, BCPL, C, C+, C++, Delphi, Fortran, Java, JavaScript, machine code, operating system command languages, Pascal, Perl, PL1, Python, scripting languages, Visual Basic, metalanguages which themselves specify programs, and all first, second, third, fourth, fifth, or further generation computer languages. Also included are database and other data schemas, and any other meta-languages. No distinction is made between languages which are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

With reference to the appended figures, components that can include memory can include non-transitory machine-readable media. The term “machine-readable medium” and “computer-readable medium” may refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including, but not limited to, non-volatile media, volatile media, and transmission media. Common forms of computer-readable media include, for example, magnetic and/or optical media such as compact disk (CD) or digital versatile disk (DVD), punch cards, paper tape, any other physical medium with patterns of holes, a RAM, a programmable read-only memory (PROM), an erasable programmable read-only memory (EPROM), a FLASH-EPROM, any other memory chip or cartridge, a carrier wave as described hereinafter, or any other medium from which a computer can read instructions and/or code. A computer program product may include code and/or machine-executable instructions that may represent a procedure, a function, a subprogram, a program, a routine, an application (App), a subroutine, a module, a software package, a class, or any combination of instructions, data structures, or program statements.

Those of skill in the art will appreciate that information and signals used to communicate the messages described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Terms, “and” and “or” as used herein, may include a variety of meanings that are also expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean A, B, C, or any combination of A, B, and/or C, such as AB, AC, BC, AA, ABC, AAB, AABBCCC, etc.

Further, while certain embodiments have been described using a particular combination of hardware and software, it should be recognized that other combinations of hardware and software are also possible. Certain embodiments may be implemented only in hardware, or only in software, or using combinations thereof. In one example, software may be implemented with a computer program product containing computer program code or instructions executable by one or more processors for performing any or all of the steps, operations, or processes described in this disclosure, where the computer program may be stored on a non-transitory computer readable medium. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques, including, but not limited to, conventional techniques for inter-process communications, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific embodiments have been described, these are not intended to be limiting. Various modifications and equivalents are within the scope of the following claims.

In view of this description, embodiments may include different combinations of features. Implementation examples are described in the following numbered clauses:
Clause 1. A regulatory approval submission and review system comprising:
   a repository configured to store a set of regulatory approval submission data and associated metadata for a medical product of a supplier; and
   a portal communicatively coupled to the repository and configured to filter, based on the associated metadata and users' roles, the set of regulatory approval submission data and the associated metadata in the repository to provide user specific submission data and metadata to users of the supplier and users of a regulatory agency.
Clause 2. The regulatory approval submission and review system of Clause 1, wherein the associated metadata includes:
   a subset of public metadata that is accessible by the users of the regulatory agency and the users of the supplier; and
   one or more subsets of supplier metadata that are accessible by the users of the supplier but are not accessible by the users of the regulatory agency, one or more subsets of agency metadata that are accessible by the users of the regulatory agency but are not accessible by the users of the supplier, or a combination thereof.
Clause 3. The regulatory approval submission and review system of Clause 2, wherein:
   the set of regulatory approval submission data includes a plurality of elements; and
   metadata associated with an element of the plurality of elements of the set of regulatory approval submission data includes an attribute indicating whether the metadata belongs to the subset of public metadata, a subset of supplier metadata of the one or more subsets of supplier metadata, or a subset of agency metadata of the one or more subsets of agency metadata.
Clause 4. The regulatory approval submission and review system of Clause 3, wherein metadata associated with the plurality of elements of the set of regulatory approval submission data is categorized or is searchable.
Clause 5. The regulatory approval submission and review system of any of Clauses 1-4, wherein the associated metadata includes comments, modifications, revision history, status, or other attributes associated with individual elements of the set of regulatory approval submission data.
Clause 6. The regulatory approval submission and review system of any of Clauses 1-5, wherein:
   the set of regulatory approval submission data is stored in the repository according to a multi-level hierarchical structure; and
   the associated metadata is stored with corresponding elements of the set of regulatory approval submission data in the multi-level hierarchical structure.
Clause 7. The regulatory approval submission and review system of Clause 6, wherein the multi-level hierarchical structure includes a project level, a section level below the project level, an assembly level below the section level, and a component level below the assembly level.
Clause 8. The regulatory approval submission and review system of any of Clauses 1-7, wherein the portal is configured to provide, based on the associated metadata and a user's role, user specific metrics data to a dashboard of a user interface.
Clause 9. The regulatory approval submission and review system of Clause 8, wherein the user specific metrics data includes user specific statistical data generated based on the associated metadata and the user's role.
Clause 10. The regulatory approval submission and review system of any of Clauses 1-9, wherein the portal is further configured to provide, based on the associated metadata, a submission knowledgebase to a user of the supplier through a user interface, the submission knowledgebase including knowledge regarding a regulatory approval submission and review process learned from pending projects and complete projects.
Clause 11. The regulatory approval submission and review system of any of Clauses 1-10, wherein the set of regulatory approval submission data includes one or more documents, one or more design files, one or more images, video content, audio content, multimedia content, or a combination thereof.
Clause 12. The regulatory approval submission and review system of any of Clauses 1-11, wherein the portal is configured to provide different data and metadata to two users of the supplier having different roles.
Clause 13. A system comprising:
   one or more processors; and
   one or more processor-readable media storing instructions which, when executed by the one or more processors, cause the one or more processors to:
      receive, from a supplier of a medical product, a set of regulatory approval submission data associated with the medical product for approval by a regulatory agency;
      store the set of regulatory approval submission data in a repository;
      receive, from users of the supplier and users of the regulatory agency, metadata associated with corresponding elements of the set of regulatory approval submission data, wherein metadata associated with an element of the set of regulatory approval submission data includes an attribute indicating accessibility of the element or the metadata associated with the element;
      store the metadata with the corresponding elements of the set of regulatory approval submission data in the repository; and
      filter, based on users' roles and the metadata associated with the corresponding elements, the set of regulatory approval submission data and the metadata associated with the corresponding elements stored in the repository to provide user specific submission data and metadata to the users of the supplier and the users of the regulatory agency.
Clause 14. The system of Clause 13, wherein the metadata associated with the corresponding elements of the set of regulatory approval submission data includes comments, modifications, questions, review decisions, revision history, status, or other attributes associated with the corresponding elements.
Clause 15. The system of Clause 13 or 14, wherein the attribute indicates whether the metadata associated with the element belongs to a subset of public metadata that is accessible by the users of the regulatory agency and the users of the supplier, a subset of supplier metadata that is accessible by the users of the supplier but is not accessible by the users of the regulatory agency, or a subset of agency metadata that is accessible by the users of the regulatory agency but is not accessible by the users of the supplier.
Clause 16. The system of any of Clauses 13-15, wherein the set of regulatory approval submission data includes one or more documents, one or more design files, one or more images, video content, audio content, multimedia content, or a combination thereof.
Clause 17. The system of any of Clauses 13-16, wherein:
   the set of regulatory approval submission data is stored in the repository according to a multi-level hierarchical structure; and
   the metadata associated with the corresponding elements of the set of regulatory approval submission data is stored with the corresponding elements in the multi-level hierarchical structure.
Clause 18. The system of any of Clauses 13-17, wherein the instructions, when executed by the one or more processors, further cause the one or more processors to provide, based on the metadata associated with the corresponding elements and a user's role, user specific metrics data to a dashboard of a user interface.
Clause 19. The system of any of Clauses 13-18, wherein the instructions, when executed by the one or more processors, further cause the one or more processors to provide, based on the metadata associated with the corresponding elements, a submission knowledgebase to a user of the supplier through a user interface, the submission knowledgebase including knowledge regarding a regulatory approval submission and review process learned from pending projects and complete projects.
Clause 20. A processor-implemented method comprising:
   receiving, from a supplier of a medical product, a set of regulatory approval submission data associated with the medical product for approval by a regulatory agency;
   storing the set of regulatory approval submission data in a repository;
   receiving, from users of the supplier and users of the regulatory agency, metadata associated with corresponding elements of the set of regulatory approval submission data, wherein metadata associated with an element of the set of regulatory approval submission data includes an attribute indicating accessibility of the element or the metadata associated with the element;
   storing the metadata with the corresponding elements of the set of regulatory approval submission data in the repository; and
   filtering, based on users' roles and the metadata associated with the corresponding elements, the set of regulatory approval submission data and the metadata associated with the corresponding elements stored in the repository to provide user specific data and metadata to the users of the supplier and the users of the regulatory agency.

What is claimed is:

1. A regulatory approval submission and review system comprising:
a repository configured to store a set of regulatory approval submission data and associated metadata for a medical product of a supplier; and
a portal communicatively coupled to the repository and configured to filter, based on the associated metadata and users' roles, the set of regulatory approval submission data and the associated metadata in the repository to provide user specific submission data and metadata to users of the supplier and users of a regulatory agency.

2. The regulatory approval submission and review system of claim 1, wherein the associated metadata includes:
a subset of public metadata that is accessible by the users of the regulatory agency and the users of the supplier; and
one or more subsets of supplier metadata that are accessible by the users of the supplier but are not accessible by the users of the regulatory agency, one or more subsets of agency metadata that are accessible by the users of the regulatory agency but are not accessible by the users of the supplier, or a combination thereof.

3. The regulatory approval submission and review system of claim 2, wherein:
the set of regulatory approval submission data includes a plurality of elements; and
metadata associated with an element of the plurality of elements of the set of regulatory approval submission data includes an attribute indicating whether the metadata belongs to the subset of public metadata, a subset of supplier metadata of the one or more subsets of supplier metadata, or a subset of agency metadata of the one or more subsets of agency metadata.

4. The regulatory approval submission and review system of claim 3, wherein metadata associated with the plurality of elements of the set of regulatory approval submission data is categorized or is searchable.

5. The regulatory approval submission and review system of claim 1, wherein the associated metadata includes comments, modifications, revision history, status, or other attributes associated with individual elements of the set of regulatory approval submission data.

6. The regulatory approval submission and review system of claim 1, wherein:
the set of regulatory approval submission data is stored in the repository according to a multi-level hierarchical structure; and
the associated metadata is stored with corresponding elements of the set of regulatory approval submission data in the multi-level hierarchical structure.

7. The regulatory approval submission and review system of claim 6, wherein the multi-level hierarchical structure includes a project level, a section level below the project level, an assembly level below the section level, and a component level below the assembly level.

8. The regulatory approval submission and review system of claim 1, wherein the portal is configured to provide, based on the associated metadata and a user's role, user specific metrics data to a dashboard of a user interface.

9. The regulatory approval submission and review system of claim 8, wherein the user specific metrics data includes user specific statistical data generated based on the associated metadata and the user's role.

10. The regulatory approval submission and review system of claim 1, wherein the portal is further configured to provide, based on the associated metadata, a submission knowledgebase to a user of the supplier through a user interface, the submission knowledgebase including knowledge regarding a regulatory approval submission and review process learned from pending projects and complete projects.

11. The regulatory approval submission and review system of claim 1, wherein the set of regulatory approval submission data includes one or more documents, one or more design files, one or more images, video content, audio content, multimedia content, or a combination thereof.

12. The regulatory approval submission and review system of claim 1, wherein the portal is configured to provide different data and metadata to two users of the supplier having different roles.

13. A system comprising:
one or more processors; and
one or more processor-readable media storing instructions which, when executed by the one or more processors, cause the one or more processors to:
receive, from a supplier of a medical product, a set of regulatory approval submission data associated with the medical product for approval by a regulatory agency;
store the set of regulatory approval submission data in a repository;
receive, from users of the supplier and users of the regulatory agency, metadata associated with corresponding elements of the set of regulatory approval submission data, wherein metadata associated with an element of the set of regulatory approval submission data includes an attribute indicating accessibility of the element or the metadata associated with the element;
store the metadata with the corresponding elements of the set of regulatory approval submission data in the repository; and
filter, based on users' roles and the metadata associated with the corresponding elements, the set of regulatory approval submission data and the metadata associated with the corresponding elements stored in the repository to provide user specific submission data and metadata to the users of the supplier and the users of the regulatory agency.

14. The system of claim 13, wherein the metadata associated with the corresponding elements of the set of regulatory approval submission data includes comments, modifications, questions, review decisions, revision history, status, or other attributes associated with the corresponding elements.

15. The system of claim 13, wherein the attribute indicates whether the metadata associated with the element belongs to a subset of public metadata that is accessible by the users of the regulatory agency and the users of the supplier, a subset of supplier metadata that is accessible by the users of the supplier but is not accessible by the users of the regulatory agency, or a subset of agency metadata that is accessible by the users of the regulatory agency but is not accessible by the users of the supplier.

16. The system of claim 13, wherein the set of regulatory approval submission data includes one or more documents, one or more design files, one or more images, video content, audio content, multimedia content, or a combination thereof.

17. The system of claim 13, wherein:
the set of regulatory approval submission data is stored in the repository according to a multi-level hierarchical structure; and
the metadata associated with the corresponding elements of the set of regulatory approval submission data is stored with the corresponding elements in the multi-level hierarchical structure.

18. The system of claim 13, wherein the instructions, when executed by the one or more processors, further cause the one or more processors to provide, based on the metadata associated with the corresponding elements and a user's role, user specific metrics data to a dashboard of a user interface.

19. The system of claim 13, wherein the instructions, when executed by the one or more processors, further cause the one or more processors to provide, based on the metadata associated with the corresponding elements, a submission knowledgebase to a user of the supplier through a user interface, the submission knowledgebase including knowledge regarding a regulatory approval submission and review process learned from pending projects and complete projects.

20. A processor-implemented method comprising:
receiving, from a supplier of a medical product, a set of regulatory approval submission data associated with the medical product for approval by a regulatory agency;
storing the set of regulatory approval submission data in a repository;
receiving, from users of the supplier and users of the regulatory agency, metadata associated with corresponding elements of the set of regulatory approval submission data, wherein metadata associated with an element of the set of regulatory approval submission data includes an attribute indicating accessibility of the element or the metadata associated with the element;
storing the metadata with the corresponding elements of the set of regulatory approval submission data in the repository; and
filtering, based on users' roles and the metadata associated with the corresponding elements, the set of regulatory approval submission data and the metadata associated with the corresponding elements stored in the repository to provide user specific data and metadata to the users of the supplier and the users of the regulatory agency.
